(19) United States
(12) Patent Application Publication
(10) Pub. No.: US 2025/0047392 A1
(43) Pub. Date: Feb. 6, 2025

(54) WIRELESS COMMUNICATION APPARATUS, WIRELESS COMMUNICATION METHOD, AND WIRELESS COMMUNICATION SYSTEM

(71) Applicant: NEC Corporation, Tokyo (JP)

(72) Inventor: Takuji MOCHIZUKI, Tokyo (JP)

(73) Assignee: NEC Corporation, Tokyo (JP)

(21) Appl. No.: 18/772,173

(22) Filed: Jul. 14, 2024

(30) Foreign Application Priority Data
Aug. 1, 2023 (JP) 2023-125255

(51) Int. Cl. H04B 17/19; H04B 7/06; H04B 17/12

(52) U.S. Cl. CPC H04B 17/19; H04B 7/0617; H04B 17/12

(57) ABSTRACT

A wireless communication apparatus includes a plurality of transceivers, a calibration transceiver, and a controller. The controller detects a malfunction of each of the plurality of transceivers, based on a downlink calibration signal being output from each of the plurality of transceivers to the calibration transceiver during a downlink calibration operation and an uplink calibration signal being output from each of the plurality of transceivers to the controller during an uplink calibration operation, and executes self-healing processing of reconstructing a downlink beam forming weight for spatial multiplexing by using the transceiver other than the malfunctioning transceiver among the plurality of transceivers.

### INCORPORATION BY REFERENCE

This application is based upon and claims the benefit of priority from Japanese patent application No. 2023-125255, filed on Aug. 1, 2023, the disclosure of which is incorporated herein in its entirety by reference.

### TECHNICAL FIELD

The present disclosure relates to a wireless communication apparatus, a wireless communication method, and a wireless communication system.

### BACKGROUND ART

An active antenna system (AAS) for the fifth generation (5G) adopts a full digital beam forming technique that enables to achieve high frequency utilization efficiency (for example, Published Japanese Translation of PCT International Publication for Patent Application, No. 2019-503116).

Further, in the AAS, achieving high-speed and large-capacity data transmission and improvement of frequency utilization efficiency by spatial multiplexing performance of massive multi-input/multi-output (MIMO) is expected. In order to achieve a 5G system that supports Beyond 5G/6G being expected to be introduced by 2030, it becomes increasingly necessary to deploy the AAS extensively.

As described above, in the future, the AAS is deployed extensively, and it is anticipated that the total number of transceivers (TRXs) operating in the AAS is consequently increased. However, there is a concern that the number of malfunctioning TRXs is increased due to aging deterioration or the like as the total number of TRXs in the AAS is increased.

The present inventor has found that, as the number of malfunctioning TRXs in the AAS is increased, variation in null depth in a direction to a terminal other than a desired terminal is significantly larger, which causes significant deterioration of spatial multiplexing performance. Description is made below on an impact of an increase of the number of malfunctioning TRXs on the null depth critical for spatial multiplexing in the AAS.

First, a configuration of an AAS 900 according to a related art is described. FIG. 1 illustrates a circuit configuration example of the AAS 900 according to the related art. Further, FIG. 2 illustrates an example of specifications of the AAS 900 according to the related art.

Note that, in FIGS. 1 and 2, it is assumed that an antenna element is configured by a ±45-degree dual polarized patch antenna. Further, it is assumed that the AAS 900 is provided with 64 antenna elements in total, specifically, a configuration of eight antennas in a horizontal direction×four antennas in a vertical direction×two polarizations. Further, it is assumed that the AAS 900 is configured in such a way that two antenna elements in the vertical direction are connected to one TRX, and it is assumed that 32 TRXs, specifically, a configuration of eight TRXs in the horizontal direction×two TRXs in the vertical directions×two polarizations are provided thereto.

Further, in FIGS. 1 and 2, it is assumed that the AAS 900 is used as a base station.

Thus, the AAS 900 executes a downlink (DL) operation of transmitting a DL signal to a plurality of pieces of user equipment (UEs), which are omitted in illustration. The DL signal is a signal acquired by applying a beam forming weight to a data transmission stream (time signal) for each layer to each of the UEs. In example embodiments described later, as one example, two-layer transmission is performed by using polarization MIMO with cross polarization. Further, the AAS 900 executes an uplink (UL) operation of receiving a UL signal from the plurality of UEs by all the antenna elements in the AAS 900.

As illustrated in FIGS. 1 and 2, the AAS 900 according to the related art includes optical transceivers 10A and 10B, a baseband (BB) unit 20, 32 TRXs 31-0 to 31-31, 32 switches (SW) 32-0 to 32-31, an antenna 40, a calibration transceiver (CAL-TRX) 51, a SW 52, and a calibration network (CAL Network). Note that, hereinafter, when description is made without specifying the TRXs 31-0 to 31-31 from one another, each of the TRXs 31-0 to 31-31 is referred to as a TRX 31-n (n=0, . . . , 31) as appropriate. Similarly, each of the SWs 32-0 to 32-31 is referred to as a SW 32-n as appropriate.

The optical transceivers 10A and 10B performs optical-to-electrical conversion and electrical-to-optical conversion of a signal being transmitted and received between a distributed unit (DU), which is omitted in illustration, and the BB unit 20.

When the DL operation is executed, the BB unit 20 outputs, to each of the TRXs 31-n, the DL signal being output from the optical transceivers 10A and 10B. Further, when the UL operation is executed, the BB unit 20 outputs, to the optical transceivers 10A and 10B, the UL signal being output from each of the TRXs 31-n.

When the DL operation is executed, the TRX 31-n converts the DL signal, which is output from the BB unit 20 and is acquired by applying a beam forming weight for each layer signal into the plurality of UEs, from an in-phase and quadrature (IQ) signal to a radio frequency (RF) signal, amplifies the signal being converted, and then outputs the signal being amplified to the SW 32-n. Further, when the UL operation is executed, the TRX 31-n amplifies the UL signal being output from the SW 32-n, converts the signal being amplified from an RF signal into an IQ signal, and then outputs the signal being converted to the BB unit 20. Thus, the TRX 31-n includes a transmitter (TX) that converts the DL signal, which is acquired by applying a beam forming weigh to each of the UEs by the BB unit 20, from an IQ signal into an RF signal, a transmission amplifier that amplifies the DL signal being output from the TX, and the like. Further, the TRX 31-n also includes a reception amplifier that amplifies the UL signal being received by a plurality of antennas configured by multiple elements being arrayed, a receiver (RX) that converts the UL signal being output from the reception amplifier from an RF signal into an IQ signal, and the like. Note that, the SW 32-n may be provided in the TRX 31-n.

The SW 32-n is a switch that switches connection between the TRX 31-n, and the antenna 40 and the CAL network 60. When the DL operation is executed, the SW 32-n outputs, to the antenna 40, the DL signal being output from the TRX 31-n. Further, when the UL operation is executed, the SW 32-n outputs, to the TRX 31-n, the UL signal being received by the antenna 40.

The antenna 40 includes the 64 antenna elements in total described above. When the DL operation is executed, each of the antenna elements transmits, to the UE, the DL signal being output from the SW 32-n. Further, when the UL operation is executed, each of the antenna elements receives the UL signal from the UE, and outputs the signal being received to the SW 32-n. Note that, details of each of the antenna elements configuring the antenna 40 are described later.

Further, the AAS 900 executes a DL calibration (CAL) operation and a UL CAL operation in order to execute UL channel sounding and DL BF at high accuracy. The DL CAL operation is an operation of aligning an amplitude phase frequency characteristic among a plurality of TXs in the AAS 900. The UL CAL operation is an operation of aligning the amplitude phase frequency characteristic among a plurality of RXs in the AAS 900.

When the DL CAL operation is executed, the BB unit 20 outputs a DL CAL signal to each of the TRXs 31-n. Further, when the UL CAL operation is executed, the BB unit 20 outputs a UL CAL signal to the CAL-TRX 51.

When the DL CAL operation is executed, the TRX 31-n converts the DL CAL signal being output from the BB unit 20 from an IQ signal into an RF signal, amplifies the signal being converted, and then outputs the signal being amplified to the SW 32-n. Further, when the UL CAL operation is executed, the TRX 31-n amplifies the UL CAL signal being output from the SW 32-n, converts the signal being amplified from an RF signal into an IQ signal, and then outputs the signal being converted to the BB unit 20.

When the DL CAL operation is executed, the SW 32-n outputs, to the CAL network 60, the DL CAL signal being output from the TRX 31-n. Further, when the UL CAL operation is executed, the SW 32-n outputs, to the TRX 31-n, the UL CAL signal being output from the CAL network 60.

When the DL CAL operation is executed, the CAL network 60 combines the DL CAL signals being output from each of the SWs 32-n with each other, and then outputs the signal being combined to the SW 52. Further, when the UL CAL operation is executed, the CAL network 60 distributes the UL CAL signal being output from the SW 52, and outputs the signal being distributed to each of the SWs 32-n.

The SW 52 is a switch that switches connection between the CAL-TRX 51 and the CAL network 60. When the DL CAL operation is executed, the SW 52 outputs, to the CAL-TRX 51, the DL CAL signal being output from the CAL network 60. Further, when the UL CAL operation is executed, the SW 52 outputs, to the CAL network 60, the UL CAL signal being output from the CAL-TRX 51.

When the DL CAL operation is executed, the CAL-TRX 51 converts the DL CAL signal being output from the SW 52 from an RF signal into an IQ signal, and then outputs the signal being converted to the BB unit 20. Further, when the UL CAL operation is executed, the CAL-TRX 51 converts the UL CAL signal being output from the BB unit 20 from an IQ signal into an RF signal, and then outputs the signal being converted to the SW 52. Thus, the CAL-TRX 51 includes a calibration receiver (CAL-RX) that converts the DL CAL signal being output from the SW 52 from an RF signal into an IQ signal, a calibration transmitter (CAL-TX) that converts the UL CAL signal being output from the BB unit 20 from an IQ signal into an RF signal, and the like.

When the DL CAL operation is executed, the BB unit 20 receives the DL CAL signal being output from the CAL-RX in the CAL-TRX 51. The DL CAL signal is in a state where the DL CAL signals that are output from the TX in each of the TRXs 31-n are performed frequency multiplexing and then the signals after frequency multiplexing are combined with each other. Thus, the BB unit 20 separates and extracts the DL CAL signal being output from the CAL-RX in the CAL-TRX 51 for the TX in each of the TRXs 31-n, and then calculates a DL CAL weight of the TX in each of the TRXs 31-n, based on the DL CAL signal being extracted. The DL CAL weight being calculated for the TX in each of the TRXs 31-n is multiplied to the DL signal passing through the TX during the DL operation.

Further, when the UL CAL operation is executed, the BB unit 20 calculates a UL CAL weight of the RX in each of the TRXs 31-n, based on the UL CAL signal being output from the RX in each of the TRXs 31-n. The UL CAL weight being calculated for the RX in each of the TRXs 31-n is multiplied to the UL signal passing through the RX during the UL operation.

Next, description is made on a configuration of a wireless communication system including the AAS 900 according to the related art as a base station. FIG. 3 illustrates a configuration example of the wireless communication system. Further, FIG. 4 illustrates an example of specifications of constituent elements configuring the wireless communication system and the UE.

As illustrated in FIGS. 3 and 4, the wireless communication system includes a center unit (CU) 300 and an access point (AP) 400. The wireless communication system illustrated in FIG. 3 is a base station system including a centralized-ran (C-RAN) configuration in which the CU 300 controls the AP 400.

FIG. 3 illustrates three APs 400. Each of the APs 400 includes one DU 200 and one or more AASs 900. The DU 200 executes digital signal processing for BF and a physical layer (PHY). The DU 200 and the AAS 900 is connected to each other via a multi-core multi-mode optical fiber (optical front haul).

Further, the CU 300 and each of the APs 400 are connected to each other via a front haul 500. For example, the front haul 500 is an optical wired network, a millimeter-wave wireless network, or the like.

Each of the APs 400 allocates two layers to one UE by zero-forcing (ZF) processing, and is capable of executing spatial multiplexing for up to eight UEs (16 layers in total).

The CU 300 executes a hybrid automatic repeat-request (H-ARQ) or adaptive modulation and coding (AMC). The AMC is controlled by outer loop link adaptation (OLLA) in such a way as to transmit by a modulation and coding scheme (MCS) satisfying a block error rate (BLER) of 10%.

Next, a configuration of the antenna 40 in the AAS 900 according to the related art is described. FIG. 5 illustrates a perspective diagram representing a configuration example of the antenna 40. Further, FIG. 6 illustrates a front diagram representing a configuration example of ±45-degree polarization antennas configuring the antenna 40.

As illustrated in FIGS. 5 and 6, the antenna 40 is configured by integrating −45-degree polarization antenna and +45-degree polarization antenna to each other. Each of the ±45-degree polarization antennas includes 32 antenna elements in total, specifically, eight antenna elements in the horizontal direction×four antenna elements in the vertical direction. Further, in each of the ±45-degree polarization antennas, two antenna elements in the vertical direction are grouped, and the two antenna elements being grouped are connected to one TRX 31-n. For example, two antenna elements of the −45-degree polarization antennas, which are located at a left end and a bottom end, are connected to the TRX 31-0. In this manner, each of the 16 TRXs 31-0 to 31-15 is connected to the −45-degree polarization antenna, and each of the 16 TRXs 31-16 to 31-31 is connected to the +45-degree polarization antenna.

Herein, a simulation for grasping a feature of a deterioration degree and variation is performed while examining a first null depth, which is critical for spatial multiplexing, in order to recognize an extent of propagation of a radiation pattern of the DL signal due to an increase of the number of malfunctioning TRXs 31-n, based on a DL beam forming pattern to the UE positioned in front of the AAS 900. Note that, the first null indicates a null closest to a main lobe of a radiation pattern, and the first null depth indicates the null depth of the first null.

Herein, it is assumed that, in the AAS 900, when all the 32 TRXs 31-n normally function, DL/UL beam forming weights (BFWs) of the DL signal and the UL signal that pass through each of the TRXs 31-n remains unchanged in boresight radiation setting (1+j0), the BFW of the malfunctioning TRX 31-n is zeroized, and thereby transmission and reception at the malfunctioning TRX 31-n is stopped.

Under this premise, while increasing the number of malfunctioning TRXs 31-n, 1,000 sets of malfunction positions of the TRX 31-n are randomly selected for each number of malfunctions, and an angle spectrum of a horizontal direction angle at each of the 1,000 sets of malfunction positions is calculated.

For example, when the number of malfunctioning TRXs 31-n is three, 1,000 sets of three antenna groups each including two antenna elements being grouped are randomly selected (FIG. 7 illustrates an example of three antenna groups being selected). Further, it is assumed that three TRXs 31-n, that are connected to the three antenna groups being selected, malfunction, and transmission and reception thereof are stopped. Further, the operation of spatial multiplexing and massive MIMO is continuously executed at the remaining 29 TRXs 31-n and 58 antenna elements, and the angle spectrum of the horizontal direction angle in such a case is calculated.

In this manner, 1,000 sets of the malfunction positions of the TRX 31-n are randomly selected for each number of malfunctioning TRXs 31-n, the angle spectrum of the horizontal direction angle is calculated at each of the 1,000 malfunction positions, and the angle spectrum being calculated is overwritten. As representative examples, FIGS. 8 to 11 illustrate an overwritten angle spectrum of the horizontal direction angle for ±45-degree polarization for cases in which the number of malfunctioning TRXs 31-n is one, two, four, and eight. Note that, in FIGS. 8 to 11, a horizontal axis indicates a horizontal direction angle as viewed from the AAS 900, and a vertical axis indicates equivalent isotropic radiated power (EIRP). As illustrated in FIGS. 8 to 11, it can be understood that, as the number of malfunctioning TRXs 31-n is increased, disruption and variation of a side lobe and the null are significantly enlarged and deteriorated.

Further, an envelope pattern is extracted from the overwritten angle spectrum of the horizontal direction angle in each of FIGS. 8 to 11 in order to recognize a deterioration condition of the null depth due to the increase of the number of malfunctioning TRXs 31-n. Further, in FIGS. 12 to 15, the envelope pattern being extracted and the angle spectrum (broken line) when all the 32 TRXs 31-n normally function are overwritten. In other words, in FIGS. 12 to 15, the envelope pattern of the angle spectrum for cases in which the number of malfunctioning TRXs 31-n is one, two, four, and eight and the angle spectrum (broken line) when all the 32 TRXs 31-n normally function are overwritten with each other. As illustrated in FIGS. 12 to 15, it can be understood that, as the number of malfunctioning TRXs 31-n is increased, a worst value of the null depth (the first null depth) between the main lobe and the side lobe, and the worst value of the null depth between the side lobes are certainly decreased and deteriorated.

Further, FIG. 16 illustrates a histogram in which the horizontal axis indicates the first null depth at each of the 1,000 malfunction positions for each number of malfunctioning TRXs 31-n and the vertical axis indicates an appearance frequency of each of the first null depths while examining the first null depth for cases in which the number of malfunctioning TRXs 31-n is one, two, four, and eight.

Further, the first null depth acquired by further increasing the number of malfunctioning TRXs 31-n is examined. In other words, in FIGS. 17 to 20, the first null depth at each of the 1,000 malfunction positions is calculated for cases in which the number of malfunctioning TRXs 31-n is three, six, twelve, and twenty-four, and a calculation result is indicated by a cumulative distribution function (CDF).

As illustrated in FIGS. 16 to 20, it can also be confirmed that, as the number of malfunctioning TRXs 31-n is increased, variation in the first null depth is gradually increased.

As described above, it can be clearly confirmed that, as the number of malfunctioning TRXs 31-n is increased, variation in the first null depth is also significantly increased, and variation of 10 dB to 20 dB or more occurs. Thus, in a case in which only a few TRXs 31-n malfunction among all the 32 TRXs 31-n, when the malfunctioning TRXs are left as they are, a DL signal-to-interference-plus-noise ratio (SINR) is significantly deteriorated during spatial multiplexing, and consequently, spatial multiplexing performance is also significantly deteriorated.

Herein, the AAS 900 has redundancy in which a plurality of TRXs 31-n are provided. Thus, in the future, maintaining spatial multiplexing performance of the AAS 900 by leveraging the redundancy and utilizing only the normally functioning TRX 31-n is considered to be crucial.

### SUMMARY

In view of the problem described above, an example object of the present disclosure is to provide a wireless communication apparatus, a wireless communication method, and a wireless communication system that can maintain spatial multiplexing performance of the wireless communication apparatus even when a malfunction occurs in a transceiver in the wireless communication apparatus.

In a first example aspect, a wireless communication apparatus includes:
a plurality of transceivers;
a calibration transceiver; and
a first controller,
wherein the first controller
   detects a malfunction of each of the plurality of transceivers, based on a downlink calibration signal being output from each of the plurality of transceivers to the calibration transceiver during a downlink calibration operation and an uplink calibration signal being output from each of the plurality of transceivers to the first controller during an uplink calibration operation, and
   executes self-healing processing of reconstructing a downlink beam forming weight for spatial multiplexing by using the transceiver other than the malfunctioning transceiver among the plurality of transceivers.

In a second example aspect, a wireless communication method performed by a wireless communication apparatus including a plurality of transceivers, a calibration transceiver, and a controller, the wireless communication method including:
a malfunction detection step of detecting a malfunction of each of the plurality of transceivers, based on a downlink calibration signal being output from each of the plurality of transceivers to the calibration transceiver during a downlink calibration operation and an uplink calibration signal being output from each of the plurality of transceivers to the controller during an uplink calibration operation; and
a reconstruction step of executing self-healing processing of reconstructing a downlink beam forming weight for spatial multiplexing by using the transceiver other than the malfunctioning transceiver among the plurality of transceivers.

In a third example aspect, a wireless communication system includes:
a first wireless communication apparatus; and
a second wireless communication apparatus, wherein
the first wireless communication apparatus includes
   a plurality of transceivers,
   a calibration transceiver, and
   a controller,
the controller detects a malfunction of each of the plurality of transceivers, based on a downlink calibration signal being output from each of the plurality of transceivers to the calibration transceiver during a downlink calibration operation and an uplink calibration signal being output from each of the plurality of transceivers to the first controller during an uplink calibration operation, and
the second wireless communication apparatus executes self-healing processing of reconstructing a downlink beam forming weight for spatial multiplexing by using the transceiver other than the malfunctioning transceiver among the plurality of transceivers.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a circuit diagram illustrating a circuit configuration example of an AAS;

FIG. 2 is a diagram illustrating an example of specifications of the AAS;

FIG. 3 is a diagram illustrating a configuration example of a wireless communication system;

FIG. 4 is a diagram illustrating an example of specifications of each constituent element and a UE configuring the wireless communication system;

FIG. 5 is a perspective diagram illustrating a configuration example of an antenna in the AAS;

FIG. 6 is a front diagram illustrating a configuration example of +45-degree polarization antennas configuring an antenna in the AAS;

FIG. 7 is a diagram illustrating an example of a malfunction position of a TRX when the number of malfunctioning TRXs is three;

FIG. 8 is a diagram illustrating an example in which an angle spectrum of a horizontal direction angle for ±45-degree polarization at each of 1,000 malfunction positions is overwritten when the number of malfunctioning TRXs is one;

FIG. 9 is a diagram illustrating an example in which the angle spectrum of the horizontal direction angle for ±45-degree polarization at each of 1,000 malfunction positions is overwritten when the number of malfunctioning TRXs is two;

FIG. 10 is a diagram illustrating an example in which the angle spectrum of the horizontal direction angle for ±45-degree polarization at each of 1,000 malfunction positions is overwritten when the number of malfunctioning TRXs is four;

FIG. 11 is a diagram illustrating an example in which the angle spectrum of the horizontal direction angle for ±45-degree polarization at each of 1,000 malfunction positions is overwritten when the number of malfunctioning TRXs is eight;

FIG. 12 is a diagram illustrating an example in which an envelope pattern extracted from FIG. 8 and the angle spectrum while all the 32 TRXs normally function are overwritten when the number of malfunctioning TRXs is one;

FIG. 13 is a diagram illustrating an example in which the envelope pattern extracted from FIG. 9 and the angle spectrum while all the 32 TRXs normally function are overwritten when the number of malfunctioning TRXs is two;

FIG. 14 is a diagram illustrating an example in which the envelope pattern extracted from FIG. 10 and the angle spectrum while all the 32 TRXs normally function are overwritten when the number of malfunctioning TRXs is four;

FIG. 15 is a diagram illustrating an example in which the envelope pattern extracted from FIG. 11 and the angle spectrum while all the 32 TRXs normally function are overwritten when the number of malfunctioning TRXs is eight;

FIG. 16 is a diagram illustrating an example of a histogram in which a horizontal axis indicates a first null depth at each of the 1,000 malfunction positions for each number of malfunctioning TRXs and a vertical axis indicates an appearance frequency of each of the first null depths;

FIG. 17 is a diagram illustrating an example in which the first null depth at each of the 1,000 malfunction positions is calculated, and a calculation result is represented by a cumulative distribution function when the number of malfunctioning TRXs is three;

FIG. 18 is a diagram illustrating an example in which the first null depth at each of the 1,000 malfunction positions is calculated, and a calculation result is represented by the cumulative distribution function when the number of malfunctioning TRXs is six;

FIG. 19 is a diagram illustrating an example in which the first null depth at each of the 1,000 malfunction positions is calculated, and a calculation result is represented by the cumulative distribution function when the number of malfunctioning TRXs is twelve;

FIG. 20 is a diagram illustrating an example in which the first null depth at each of the 1,000 malfunction positions is calculated, and a calculation result is represented by the cumulative distribution function when the number of malfunctioning TRXs is twenty-four;

FIG. 21 is a circuit diagram illustrating a circuit configuration example of the AAS;

FIG. 22 is a diagram illustrating an example of an outdoor real environment assumed in a simulation;

FIG. 23 is a conceptual diagram illustrating an example of simulative self-healing processing;

FIG. 24 is a conceptual diagram illustrating an example of the simulative self-healing processing;

FIG. 25 is a conceptual diagram illustrating an example of the simulative self-healing processing;

FIG. 26 is a flowchart illustrating an example of a flow of the simulative self-healing processing;

FIG. 27 is a schematic diagram illustrating an example of the simulative self-healing processing;

FIG. 28 is a diagram illustrating an example of a radiation pattern of a DL signal being radiated from the AAS to a UE #0 when all the 32 TRXs normally function;

FIG. 29 is a diagram illustrating an example of a radiation pattern of a DL signal being radiated from the AAS to a UE #1 when all the 32 TRXs normally function;

FIG. 30 is a diagram illustrating an example of a radiation pattern of a DL signal being radiated from the AAS to a UE #2 when all the 32 TRXs normally function;

FIG. 31 is a diagram illustrating an example of a two-layer average DL SINR and a total transmission capacity of a DL signal to each of the three UEs #0, #1, and #2 when all the 32 TRXs normally function;

FIG. 32 is a diagram illustrating an example of a two-layer average DL SINR and a total transmission capacity of a DL signal to each of the three UEs #0, #1, and #2 before and after execution of self-healing when the number of malfunctioning TRXs is three;

FIG. 33 is a diagram illustrating an example of a two-layer average DL SINR and a total transmission capacity of a DL signal to each of the three UEs #0, #1, and #2 before and after execution of self-healing when the number of malfunctioning TRXs is six;

FIG. 34 is a diagram illustrating an example of a two-layer average DL SINR and a total transmission capacity of a DL signal to each of the three UEs #0, #1, and #2 before and after execution of self-healing when the number of malfunctioning TRXs is twelve;

FIG. 35 is a diagram illustrating an example of a malfunctioning position that causes a worst value of the first null depth when the number of malfunctioning TRXs is three;

FIG. 36 is a diagram illustrating an example of a radiation pattern of a DL signal being radiated from the AAS to the UE #0 when the three UEs #0, #1, and #2 are subjected to spatial multiplexing after execution of self-healing in a state where the malfunction position of the TRX is as illustrated in FIG. 35;

FIG. 37 is a diagram illustrating an example of a radiation pattern of a DL signal being radiated from the AAS to the UE #0 after execution of self-healing in the state where the malfunction position of the TRX is as illustrated in FIG. 35;

FIG. 38 is a diagram illustrating an example of the malfunctioning position that cause the worst value of the first null depth when the number of malfunctioning TRXs is six;

FIG. 39 is a diagram illustrating an example of a radiation pattern of a DL signal being radiated from the AAS to the UE #0 when the three UEs #0, #1, and #2 are subjected to spatial multiplexing after execution of self-healing in a state where the malfunction position of the TRX is as illustrated in FIG. 38;

FIG. 40 is a diagram illustrating an example of a radiation pattern of a DL signal being radiated from the AAS to the UE #0 after execution of self-healing in the state where the malfunction position of the TRX is as illustrated in FIG. 38;

FIG. 41 is a diagram illustrating an example of the malfunctioning position that cause the worst value of the first null depth when the number of malfunctioning TRXs is twelve;

FIG. 42 is a diagram illustrating an example of a radiation pattern of a DL signal being radiated from the AAS to the UE #0 when the three UEs #0, #1, and #2 are subjected to spatial multiplexing after execution of self-healing in a state where the malfunction position of the TRX is as illustrated in FIG. 41;

FIG. 43 is a diagram illustrating an example of a radiation pattern of a DL signal being radiated from the AAS to the UE #0 after execution of self-healing in the state where the malfunction position of the TRX is as illustrated in FIG. 41;

FIG. 44 is a diagram illustrating an example of a radiation pattern of a DL signal being radiated from the AAS to the UE #0 when all the 32 TRXs normally function;

FIG. 45 is a diagram illustrating an example of a radiation pattern of a DL signal being radiated from the AAS to the UE #0 before execution of self-healing when the number of malfunctioning TRXs is twelve;

FIG. 46 is a diagram illustrating an example of a radiation pattern of a DL signal being radiated from the AAS to the UE #0 after execution of self-healing when the number of malfunctioning TRXs is twelve;

FIG. 47 is a diagram illustrating a comparison example between an average DL SINR of the three UEs #0, #1, and #2 before and after execution of self-healing and an average DL SINR when all the 32 TRXs normally function, in cases in which the number of malfunctioning TRXs is three, six, twelve, eighteen, and twenty-four;

FIG. 48 is a diagram illustrating a comparison example between an average transmission capacity of the three UEs #0, #1, and #2 before and after execution of self-healing and an average transmission capacity when all the 32 TRXs normally function, in cases in which the number of malfunctioning TRXs is three, six, twelve, eighteen, and twenty-four;

FIG. 49 is a diagram illustrating an example of an average power loss of the three UEs #0, #1, and #2 before and after execution of self-healing in cases in which the number of malfunctioning TRXs is three, six, twelve, eighteen, and twenty-four;

FIG. 50 is a diagram illustrating an arrangement example of antenna elements configuring an antenna;

FIG. 51 is a diagram illustrating a comparison example between a radiation pattern of a DL signal being radiated from the AAS to the UE before execution of self-healing and a radiation pattern of a DL signal being radiated from the AAS to the UE when all the 32 TRXs normally function, for each malfunction position, when the number of malfunctioning TRXs is one;

FIG. 52 is a diagram illustrating an example in which the horizontal axis indicates a column number of a malfunction position and the vertical axis indicates the first null depth before execution of self-healing for each column number when the number of malfunctioning TRXs is one;

FIG. 53 is a diagram illustrating an example of the first null depth before execution of self-healing at each of malfunction positions of sample numbers 1 to 4 when the number of malfunctioning TRXs is two;

FIG. 54 is a diagram illustrating an example of the first null depth before execution of self-healing at each of malfunction positions of sample numbers 5 to 10 when the number of malfunctioning TRXs is two;

FIG. 55 is a circuit diagram illustrating a circuit configuration example of the wireless communication apparatus;

FIG. 56 is a flowchart illustrating an example of a schematic operation flow of the wireless communication apparatus;

FIG. 57 is a circuit diagram illustrating a circuit configuration example of the wireless communication system; and

FIG. 58 is a block diagram illustrating a hardware configuration example of a computer that achieves some of functions of the wireless communication apparatus.

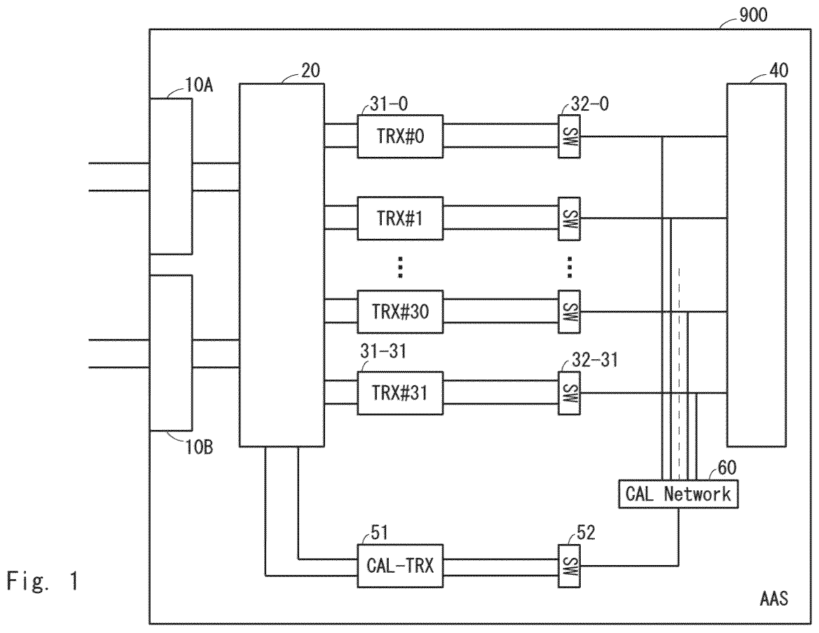

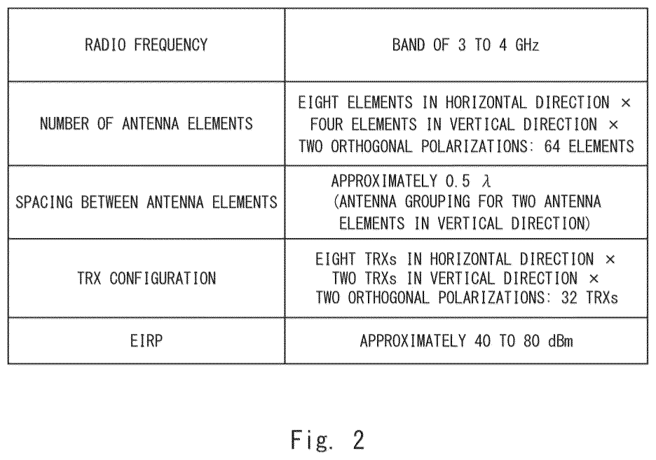

### EXAMPLE EMBODIMENT

Example embodiments of the present disclosure are described below with reference to the drawings. Note that, the following description and the drawings are appropriately omitted and simplified for clarity of description. Further, in the following drawings, the same elements are denoted by the same reference signs, and repetitive description thereof is omitted as required. Further, a specific numeral value and the like given below are merely examples for easy understanding of the present disclosure, and are not limited thereto.

### First Example Embodiment

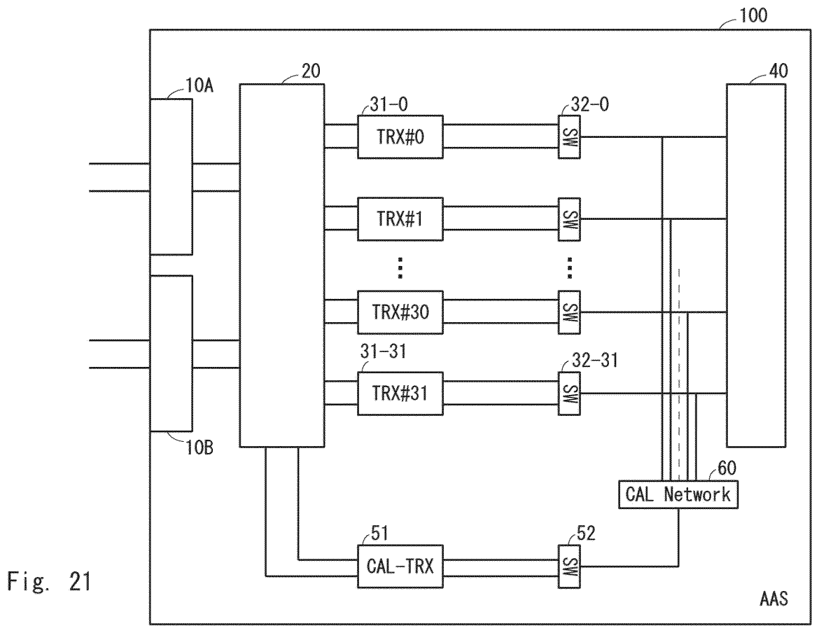

First, a configuration of an AAS 100 according to a first example embodiment is described. FIG. 21 illustrates a circuit configuration example of the AAS 100 according to the first example embodiment.

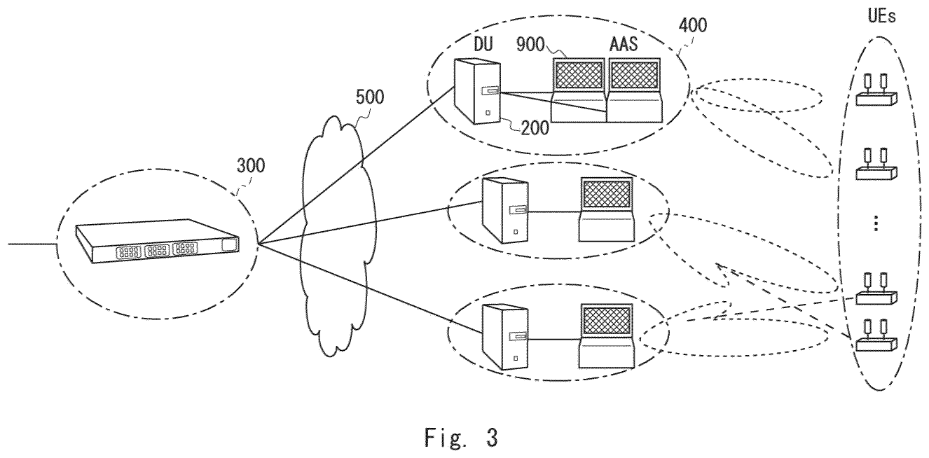

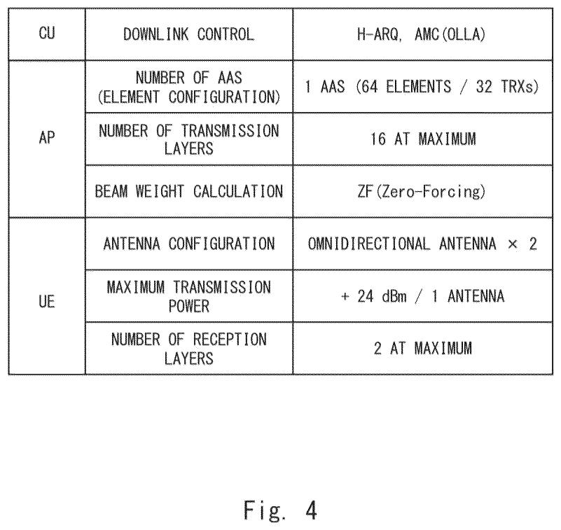

As illustrated in FIG. 21, the configuration itself of the AAS 100 according to the present first example embodiment is similar to that of the AAS 900 according to the related art. Further, the AAS 100 is also similar to the AAS 900 in that the AAS 100 can be installed as the constituent element of the AP 400 in the wireless communication system illustrated in FIG. 3. However, the AAS 100 is different from the AAS 900 in an operation.

As described above, it is confirmed that, in the AAS 900 according to the related art, as the number of malfunctioning TRXs 31-n is increased, variation in a first null depth is also significantly increased. Thus, in a case in which only a few TRXs 31-n malfunction among all the 32 TRXs 31-n, when the malfunctioning TRXs are left as they are, there is a problem that a DL SINR is significantly deteriorated during spatial multiplexing, and consequently, spatial multiplexing performance is also significantly deteriorated.

In contrast, when massive MIMO/spatial multiplexing is executed, the AAS 100 according to the present first example embodiment does not leave the malfunctioning TRX 31-n as it is, and executes detection of the malfunctioning TRX 31-n. In this state, specifically, the AAS 100 executes detection of the malfunctioning TRX 31-n, based on an amplitude or a phase of a DL CAL signal being output from a TX in each of the TRXs 31-n to a CAL-TRX 51 during a DL CAL operation, and an amplitude or a phase of a UL CAL signal being output from an RX in each of the TRXs 31-n to a BB unit 20 during a UL CAL operation.

Further, the AAS 100 stops transmission and reception at the malfunctioning TRX 31-n, uses only the normally functioning TRX 31-n, and executes self-healing for reconstructing a DL BFW. In this state, specifically, the AAS 100 derives a DL transmission path matrix (=UL transmission path matrix), based on reception of a sounding reference signal (SRS) from a UE, substitutes 0 (zero) for a propagation path matrix element of the malfunctioning TRX 31-n, executes zero-forcing (ZF) processing, and derives a new DL BFW. Note that, the ZF processing is described later.

With this, the AAS 100 is capable of maintaining a null depth in a direction to a UE other than a desired UE and autonomously restoring spatial multiplexing performance.

Note that, it is assumed that the above-mentioned operation of the AAS 100 is executed by the BB unit 20. Further, it is assumed that, among operations of the AAS 100, which are described later, an operation whose actor is not specified is also executed by the BB unit 20.

Description is made below on the number of malfunctioning TRXs 31-n in an outdoor real environment and self-healing processing by the AAS 100 according to the present first example embodiment by actual measurement and a simulation.

First, for describing the self-healing processing by the AAS 100 according to the present first example embodiment, description is made on a result of performing a statistic characteristic evaluation in a simulation when a plurality of UEs are variously arranged.

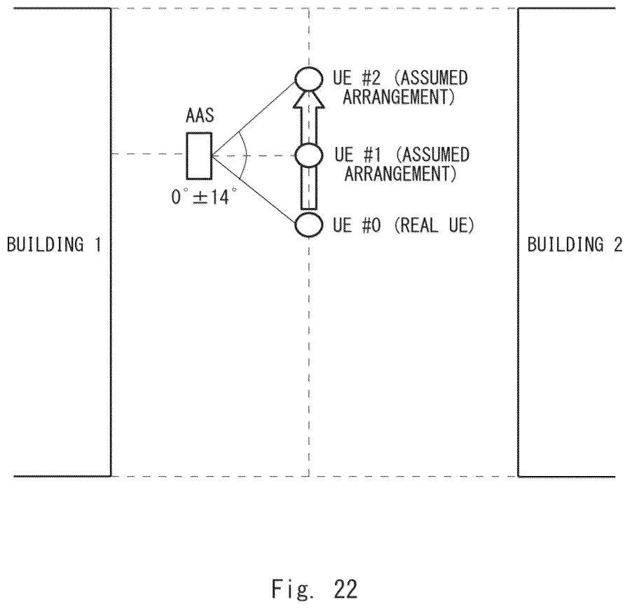

As the outdoor real environment assumed in the simulation, an experiment system is constructed in an outdoor real environment illustrated in FIG. 22. Note that, FIG. 22 is a plane view of the AAS 100 and the UE as viewed from above.

In FIG. 22, the UEs are caused to move linearly at a constant walking speed in a state of being away from each other in front of the AAS 100. Further, at positions equivalent to a UE #0, a UE #1, and a UE #2, SRSs are transmitted from the UEs, and the SRSs are caused to be received by all the RXs (32 RXs in a normal state) in the AAS 100. Further, a UL SRS channel estimation value in the outdoor real environment illustrated in FIG. 22, in other words, Hₖ equivalent to the DL transmission path matrix during time division duplex (TDD) is measured based on an SRS reception result.

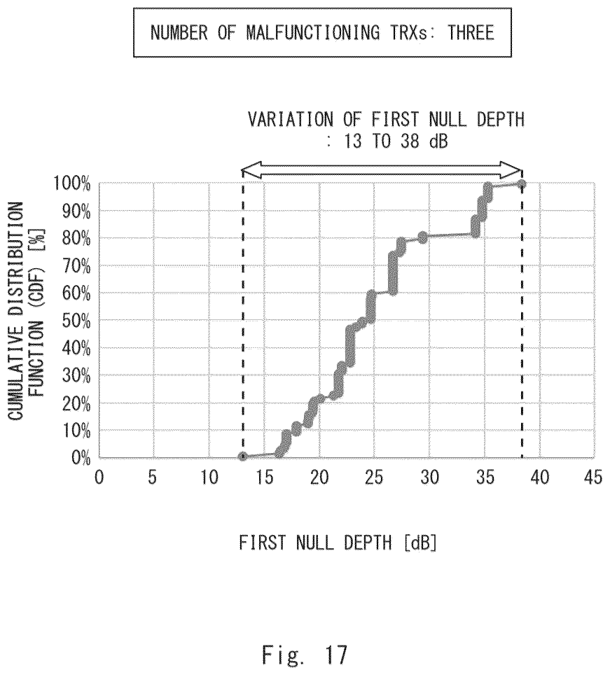

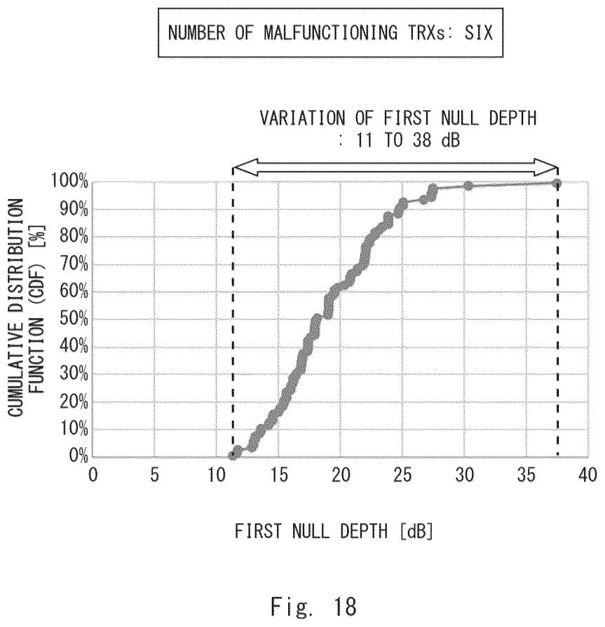

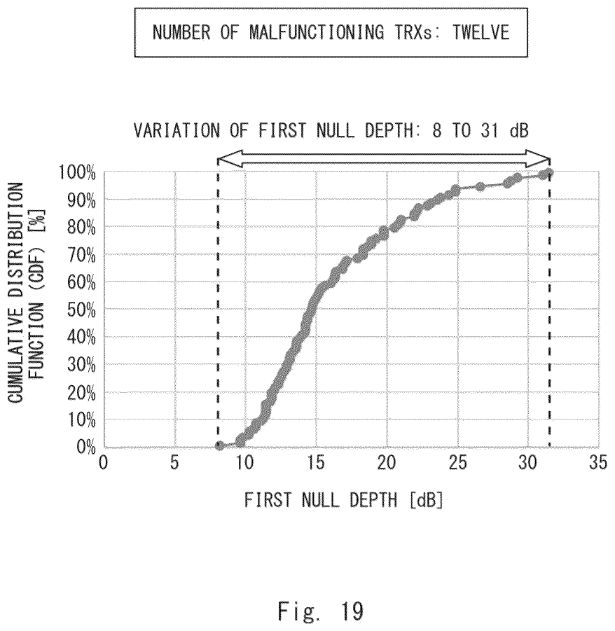

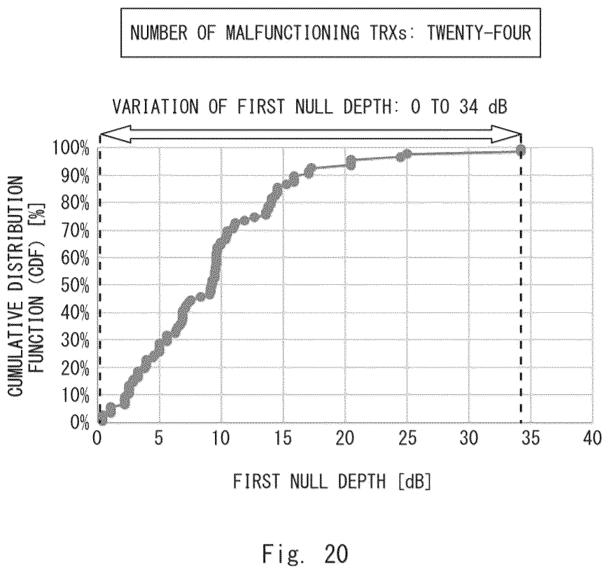

Further, it is assumed that the three UEs #0, #1, and #2 are installed at an equal angle interval (at an interval of 0 degree ±14 degrees in the present description) as viewed from the AAS 100 and DL/UL transmission is performed between the AAS 100 and each of the three UEs. Further, based on insight acquired in FIGS. 17 to 20, a malfunction position indicating a worst first null depth for each number of malfunctioning TRXs 31-n is selected, and SRS reception data at the malfunction position being selected are zeroized (in other words, zero is substituted for the propagation path matrix element of the malfunction position). With this, an arrangement situation of the malfunctioning TRXs 31-n is simulatively generated.

Then, the ZF processing is executed by only using SRS reception data relating to the TRX 31-n that remains functioning normally, a three-spatial multiplexing DL BFW (W_{ZF}) is calculated again, and an improvement degree of the null depth by self-healing is confirmed.

The above-mentioned simulative self-healing processing is described below more specifically.

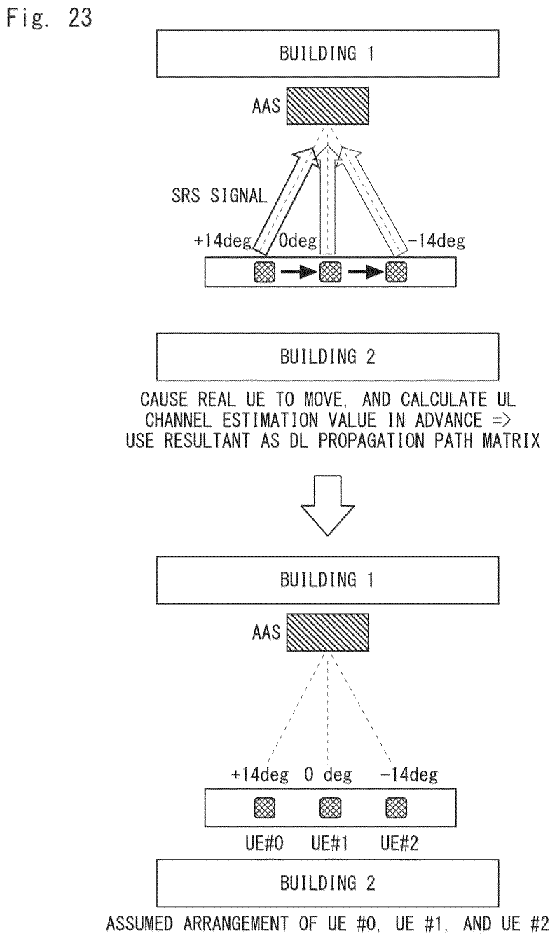

First, with reference to conceptual diagrams in FIGS. 23 to 25, the above-mentioned simulative self-healing processing is described.

FIG. 23 is a conceptual diagram illustrating that each of UL channel estimation values between the AAS 100 and each of the three UEs #0, #1, and #2 is calculated.

As illustrated in FIG. 23, while the UEs are caused to linearly move in front of the AAS 100, the SRSs are transmitted from the UEs at positions equivalent to the three UEs #0, #1, and #2, and the SRSs are caused to be received by all the RXs in the AAS 100. Further, based on an SRS reception result, each of the UL channel estimation values between the AAS 100 and each of the three UEs #0, #1, and #2 is calculated in advance. Hereinafter, the UL channel estimation value being calculated is used as each of the DL transmission path matrices between the AAS 100 and each of the three UEs #0, #1, and #2.

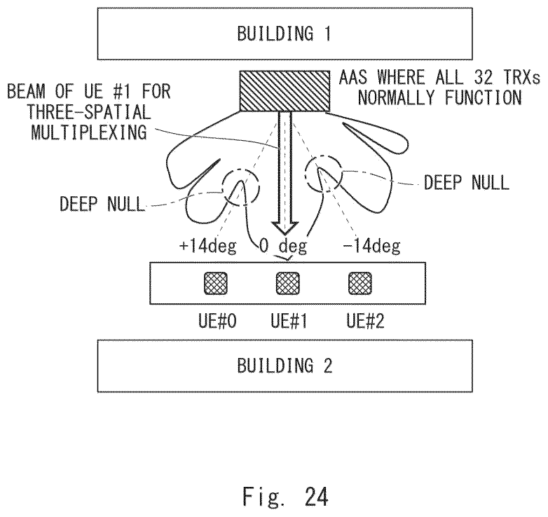

FIG. 24 illustrates a situation where the three UEs #0, #1, and #2 are subjected to spatial multiplexing in a state where all the 32 TRXs 31-n in the AAS 100 normally function.

As illustrated in FIG. 24, it can be understood that, in a radiation pattern of a DL signal emitted to the UE #1, nulls deep in directions to the UE #0 and the UE #2 are formed, and interference with the UE #0 and the UE #2 is avoided. Thus, the DL SINR of each of the three UEs #0, #1, and #2 is secured.

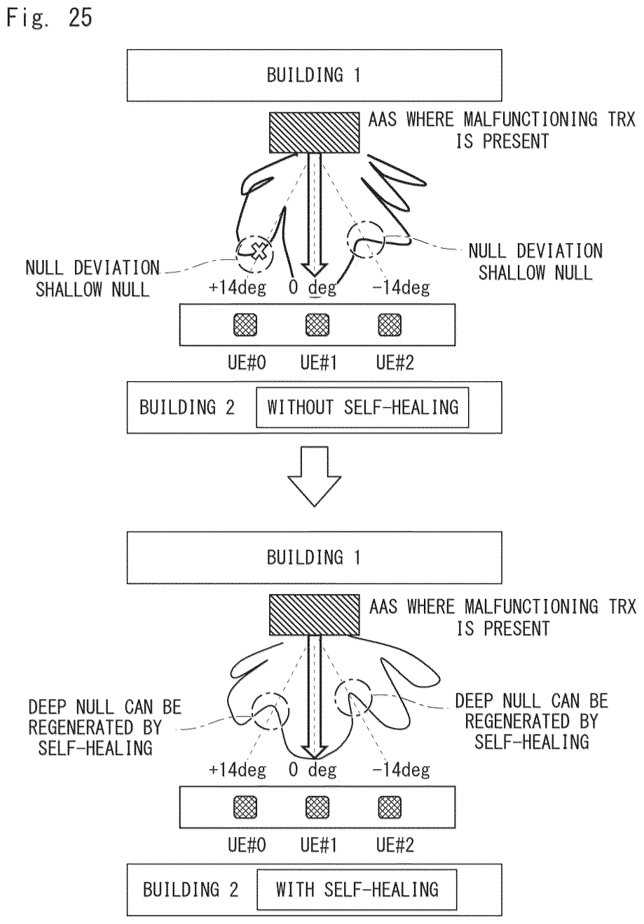

FIG. 25 illustrates a situation where the three UEs #0, #1, and #2 are subjected to spatial multiplexing before and after execution of the self-healing processing in a state where a malfunction occurs in a TRX 31-n in the AAS 100.

As illustrated in FIG. 25, it can be understood that, when the self-healing processing is not executed, in the radiation pattern of a DL signal emitted to the UE #1, null deviation in the directions to the UE #0 and the UE #2 occurs, and only nulls shallow in the directions to the UE #0 and the UE #2 are formed.

In contrast, it can be understood that, when the self-healing processing is executed, only the SRS reception data relating to the TRX 31-n that remains functioning normally is used, the ZF processing is executed, and a three-spatial multiplexing DL BFW is calculated again, and thereby nulls deep in the directions to the UE #0 and the UE #2 are formed again in the radiation pattern of the DL signal emitted to the UE #1.

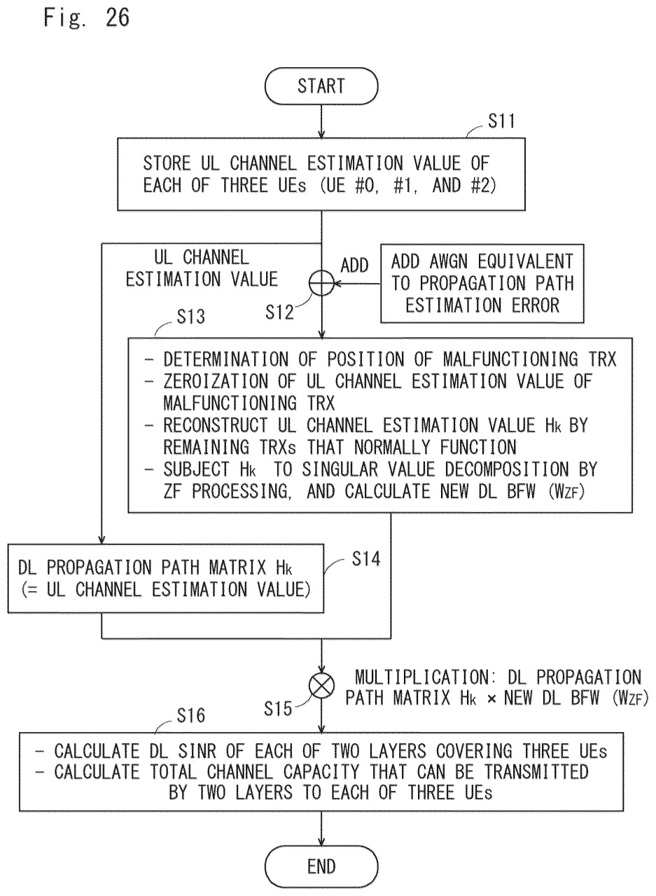

Next, with reference to a flowchart in FIG. 26, the above-mentioned simulative self-healing processing is described. Note that, in FIG. 26, it is assumed that each of the UL channel estimation values between the AAS 100 and each of the three UEs #0, #1, and #2 is calculated in advance, based on actual measurement.

As illustrated in FIG. 26, first, the AAS 100 stores the UL channel estimation value being calculated for each of the three UEs #0, #1, and #2 (step S11).

Subsequently, the AAS 100 adds, to the UL channel estimation value of each of the three UEs #0, #1, and #2, as an SNR of 20 dB, additive white gaussian noise equivalent to a propagation path estimation error (step S12).

Subsequently, the AAS 100 detects the malfunctioning TRX 31-n, based on an amplitude or a phase of the DL CAL signal being output from the TX in each of the TRXs 31-n during the DL CAL operation and an amplitude or a phase of the UL CAL signal being output from the RX in each of the TRXs 31-n during the UL CAL operation. Subsequently, the AAS 100 zeroizes the UL channel estimation value of the malfunctioning TRX 31-n (in other words, zeroizes a matrix element of the malfunctioning TRX 31-n in the UL propagation path matrix). Subsequently, the AAS 100 reconstructs the UL propagation path matrix Hₖ with the UL channel estimation value of the TRX 31-n that remains functioning normally. Subsequently, the AAS 100 subjects Hₖ to singular value decomposition during the ZF processing, and calculates again, as a new DL BFW (W_{ZF}), a generalized inverse matrix of a matrix consisting of right singular vectors being acquired (step S13).

Subsequently, the AAS 100 zeroizes the matrix element of the malfunctioning TRX 31-n, uses the UL propagation path matrix consisting of the UL channel estimation value as a DL propagation path matrix Hₖ (step S14), and multiplies a new DL BFW (W_{ZF}) thereto (step S15).

Subsequently, the AAS 100 calculates a DL SINR of a two-layer DL signal to each of the three UEs #0, #1, and #2. Note that, with respect to a desired wave S emitted in the direction to each of the UEs, the radiation pattern generated in the other two UEs includes an interference wave component “I” being generated as null accuracy (a null depth, a null direction) generated in the direction to each of the UEs is degraded. The DL SINR can be calculated by using the interference wave component “I”. Subsequently, the AAS 100 calculates a total channel capacity [bps/Hz] that can be transmitted in two layers to each of the three UEs #0, #1, and #2 using Shannon's theorem (C=B×Log 2 (1+S/N)) (Step S16). With this, improvement and effectiveness of spatial multiplexing performance through the self-healing function when the TRX 31-n malfunctions is quantitatively evaluated. Note that, a band width B substituted in Shannon's theorem is assumed to be 100 MHz. Further, in the present description, a distance between the AAS 100 and each of the three UEs #0, #1, and #2 is assumed to be several tens of meters, and hence an S/N is a high S/N. Thus, in particular, the DL SINR is dominantly determined by an SIR associated with the null depth, where the interference wave component “I” from the radiation pattern to the other UEs during spatial multiplexing is dominant rather than thermal noise “N”. Thus, by calculating and substituting the SIR, a transmission capacity C (normalized per Hz with units [bps/Hz]) to each of the UEs is acquired.

Note that, the processing in steps S14 to S16 illustrated in FIG. 26 is processing executed for examining the above-mentioned simulative self-healing processing, and is processing not required for actual self-healing processing. Details of an examination result acquired in the processing in steps S14 to S16 are described later.

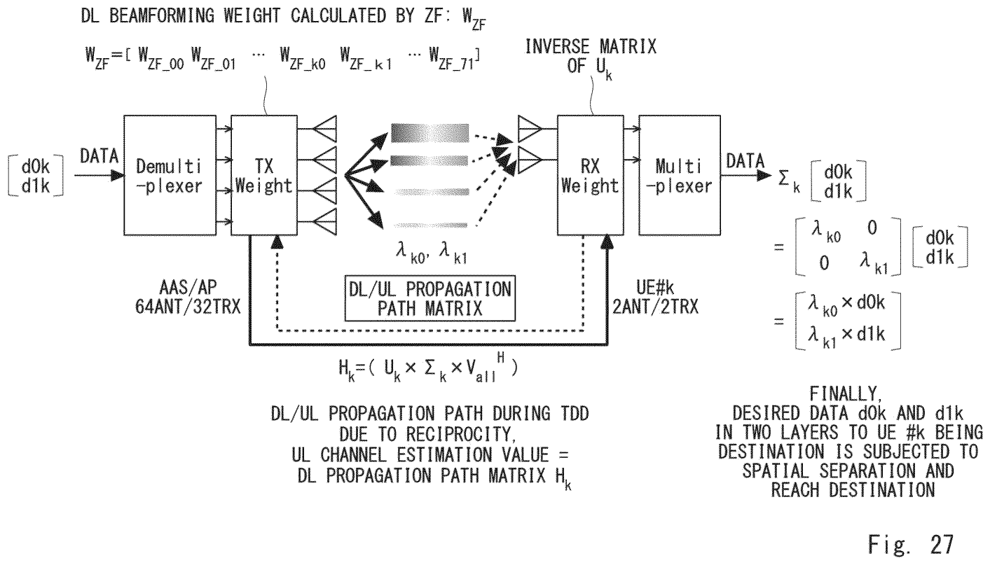

Next, with reference to a schematic diagram in FIG. 27, the above-mentioned simulative self-healing processing is described. FIG. 27 illustrates the DL propagation path matrix (=the UL propagation path matrix) Hₖ between the AAS 100/the AP 400 and a UE #k when two layers to each of the eight UEs, in other words, 16 layers are subjected to spatial multiplexing. Further, FIG. 27 illustrates processing in which the AAS 100 transmits a DL signal by using the DL BFW (W_{ZF}) being calculated by the ZF processing and the UE #k extracts a two-layer DL signal.

In FIG. 27, Hₖ is the UL propagation path matrix of [2×32] for the UE #k. Hₖ is equivalent to the DL propagation path matrix through reciprocity of transmission and reception by TDD.
A^{H}
indicates an adjoint matrix of A (Hermitian transpose).

When Hₖ is subjected to singular value decomposition, the following equation is given.

$${H}_{k} = ( {U}_{k} \times {\sum }_{k} \times {V}_{k}^{H} ) \qquad ( 1 )$$

Herein, Uₖ, Σₖ, and Vₖ are as follows.

Uₖ: a [2×2] matrix being acquired by subjecting Hₖ to singular value decomposition. And it is a left singular matrix.

Vₖ: a [32×32] matrix being acquired by subjecting Hₖ to singular value decomposition. And it is a right singular matrix.

Σₖ: a [2×32] matrix being acquired by subjecting Hₖ to singular value decomposition, and it is expressed as the following equation.

$$\sum = [ \begin{matrix}{λ}_{k 0} & 0 & \\ & & 0 … 0 \\ 0 & {λ}_{k 1} & \end{matrix} ]$$

Herein, λₖ₀ and λₖ₁ are singular values.

Further, for separating DL signals for the eight UEs, a matrix Vall [32×16] consisting of the right singular vectors for the eight UEs is considered, which is expressed as the following equation.

$${V}_{all} = [ \begin{matrix}{v}_{00} & {v}_{01} & {v}_{10} & {v}_{11} & … & {v}_{70} & {v}_{71} ]\end{matrix} \qquad ( 2 )$$

Herein, vₖ₀ and vₖ₁ are right singular vectors of the UE #k (two right singular vectors for two layers).

Further, the DL BFW (W_{ZF}) by the ZF processing becomes a generalized inverse matrix of
Vₐₗₗ^{H}
as the following equation.

$${W}_{ZF} = {( {V}_{all}^{H} )}^{+} = {{V}_{all} ( {V}_{all}^{H} {V}_{all} )}^{- 1} \qquad ( 3 )$$

Herein, a W_{ZF} is a [32×16] matrix. 16 of a column means 8 UEs×2 layers=16.

In other words, in the present first example embodiment, calculation of the DL BFW (W_{ZF}) during the ZF processing means that the DL propagation path matrix (=the UL propagation path matrix) acquired by zeroizing the matrix element of the malfunctioning TRX 31-n is subjected to singular value decomposition and a generalized inverse matrix of a matrix consisting of right singular vectors being acquired is derived as the DL BFW (W_{ZF}).

Herein, a weighting matrix multiplied to a DL signal of the UE #k is expressed as the following equation.

$${H}_{k} \times {W}_{ZF} = ( {U}_{k} \times {\sum }_{k} \times {[ {v}_{k 0} {v}_{k 1} ]}^{H} ) \times {W}_{ZF} = {U}_{k} \times {\sum }_{k} \times [ {0}_{0} {0}_{1} … {0}_{k - 1} {E}_{k} {0}_{k + 1} … {0}_{7} ] \qquad ( 4 )$$

In the equation (4), in the brackets [ ], only the k-th item becomes Eₖ, and the others become 0ᵢ.

Eₖ and 0ᵢ are expressed as the following equations.

$${E}_{k} = [ \begin{matrix}1 & 0 \\ 0 & 1\end{matrix} ] ,$$

$${0}_{i} = [ \begin{matrix}0 & 0 \\ 0 & 0\end{matrix} ]$$

Thus, when the following equation (5) is satisfied, only the equation (6) becomes Eₖ, and positions to which other W_{zf} components are multiplied become 0.

$${W}_{ZF} = [ {W}_{ZF \_ 00} {W}_{ZF \_ 01} … {W}_{ZF \_ k 0} {W}_{ZF \_ k 1} … {W}_{ZF \_ 71} ] \qquad ( 5 )$$

$${[ {v}_{k 0} {v}_{k 1} ]}^{H} \times [ {W}_{ZF \_ k 0} {W}_{ZF \_ k 1} ] \qquad ( 6 )$$

In other words, a signal being received by the UE #k via the DL propagation path matrix Hₖ is only a two-layer DL signal to the UE #k to which λₖ₀ and λₖ₁ are multiplied.

With this, spatial multiplexing is executed thoroughly. The physical implication is that, for a DL radiation pattern to the UE #k, the nulls deep in layer directions to the other UEs are formed, while, for the radiation pattern to the other UEs, the null deep in the direction to the UE #k is formed, and this equivalence avoids interference of the radiation pattern between the plurality of UEs.

An effect of the AAS 100 according to the present first example embodiment is described below.

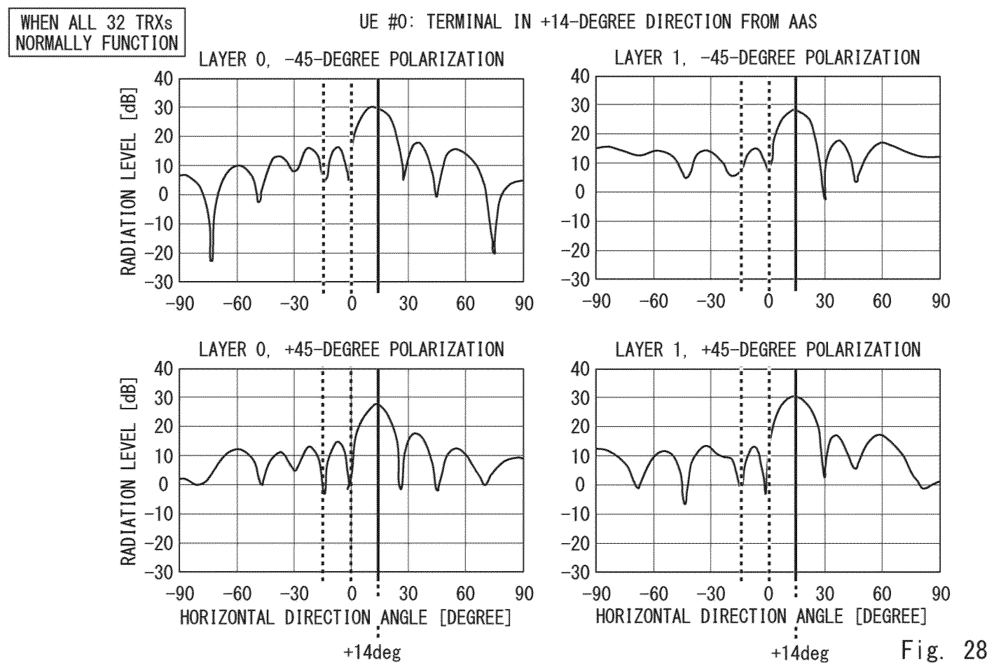

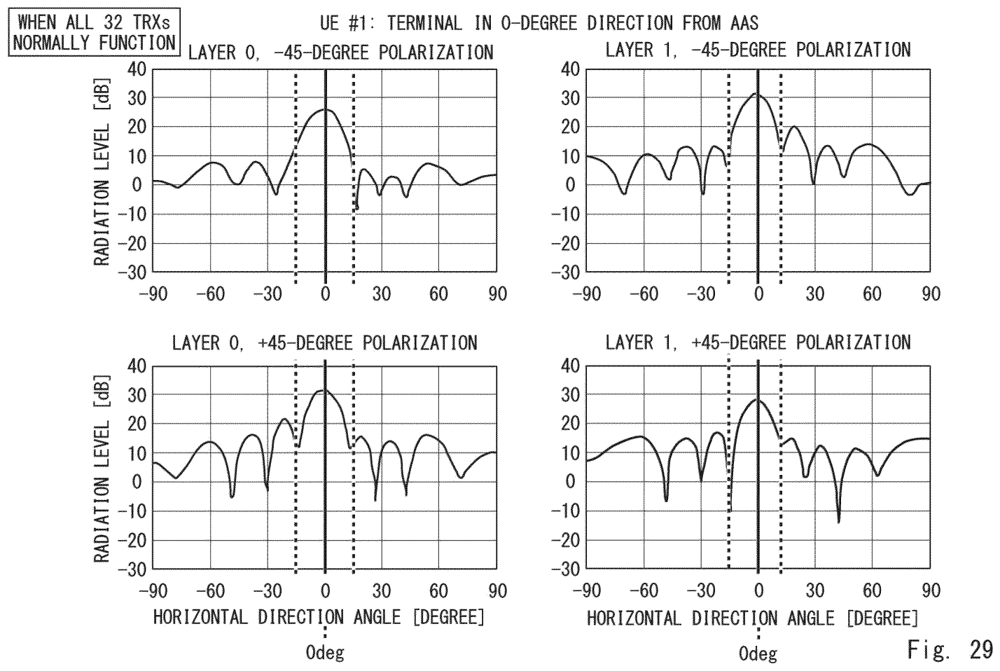

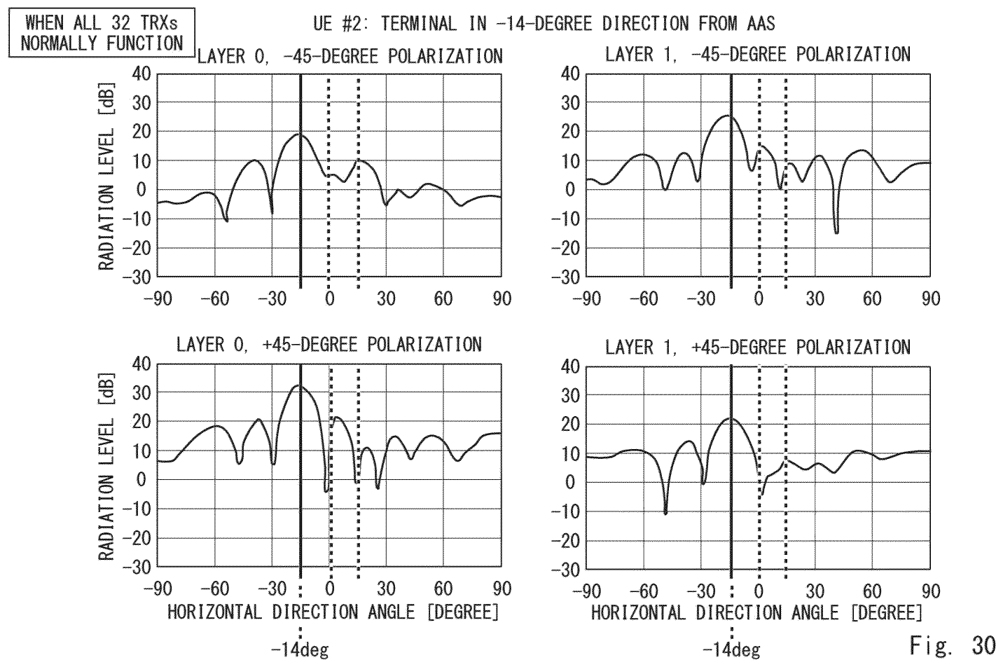

First, FIGS. 28 to 30 illustrate examples of the radiation pattern of the DL signal being radiated from the AAS 100 to each of the three UEs #0, #1, and #2 when all the 32 TRXs 31-n normally function. FIGS. 28 to 30 illustrate the examples of the radiation patterns of ±45-degree polarization transmitted in two layers (a layer 0 and a layer 1), as the radiation pattern of the DL signal being radiated to each of the UE #0, the UE #1, and the UE #2 in a +14-degree direction, a 0-degree direction, and a −14-degree direction, respectively, from the AAS 100. Note that, in FIGS. 28 to 30, a horizontal axis indicates a horizontal direction angle as viewed from the AAS 100, and a vertical axis indicates a radiation level. Further, in FIGS. 28 to 30, the horizontal direction angle in the directions to the other two UEs is indicated with auxiliary broken lines, and thereby a result of formation of the null in the directions to the other two UEs is intelligibly indicated.

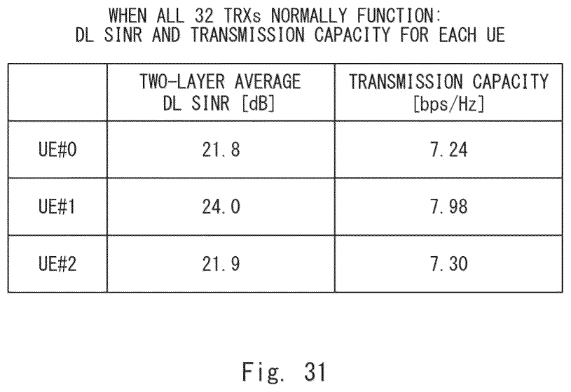

Further, FIG. 31 illustrates an example of a two-layer average DL SINR and a total transmission capacity C of the DL signal to each of the three UEs #0, #1, and #2 when all the 32 TRXs 31-n normally function.

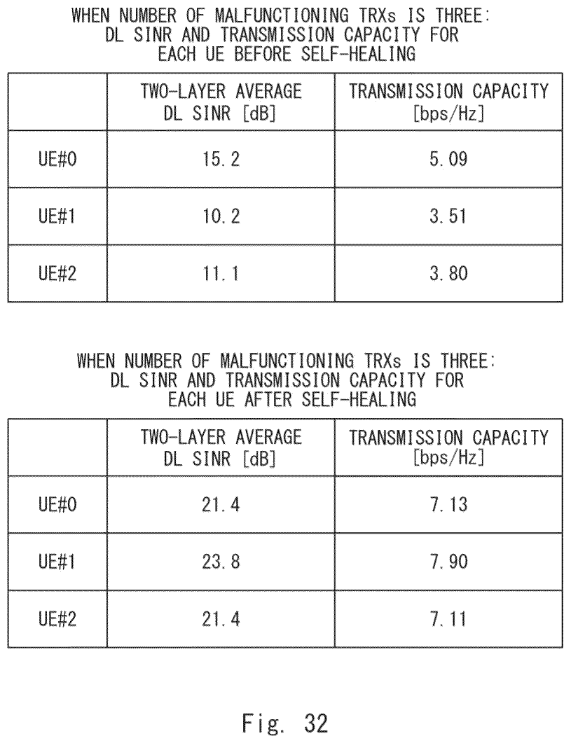

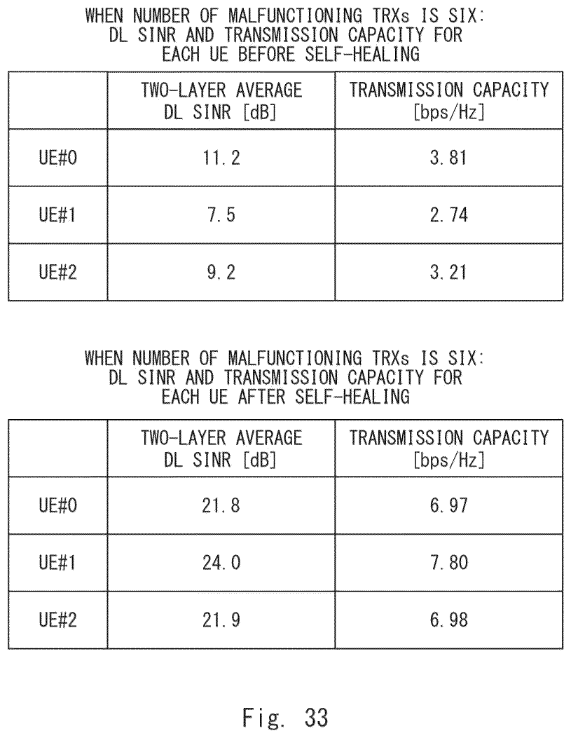

Next, FIGS. 32 to 34 illustrate examples of the two-layer average DL SINR and the total transmission capacity C of the DL signal to each of the three UEs #0, #1, and #2 before and after execution of self-healing when the number of malfunctioning TRXs 31-n is three, six, and twelve, respectively. Note that, for calculation in FIGS. 32 to 34, a malfunction position at which the first null depth being calculated each of 1,000 malfunction positions of the TRX 31-n becomes a worst value (the shallowest pattern) is selected as the malfunction position of the TRX 31-n.

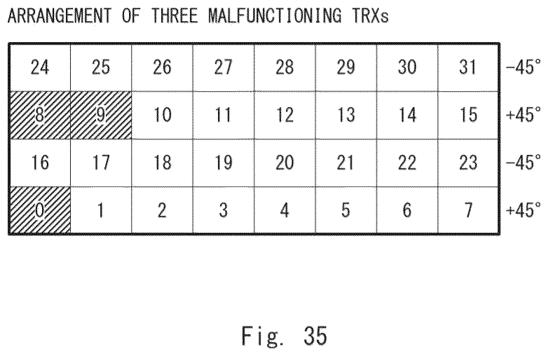

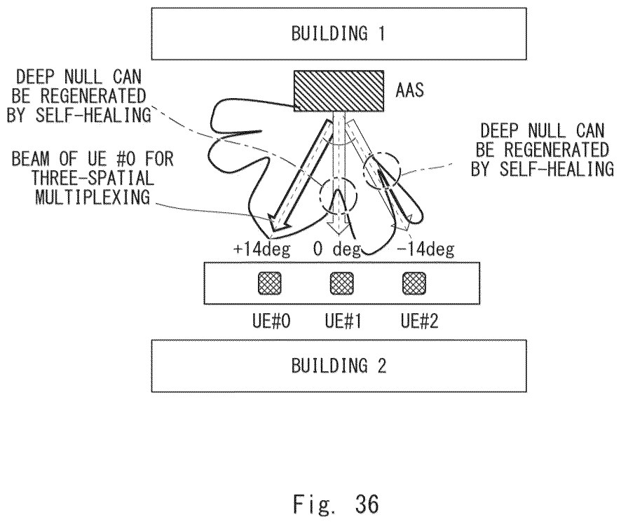

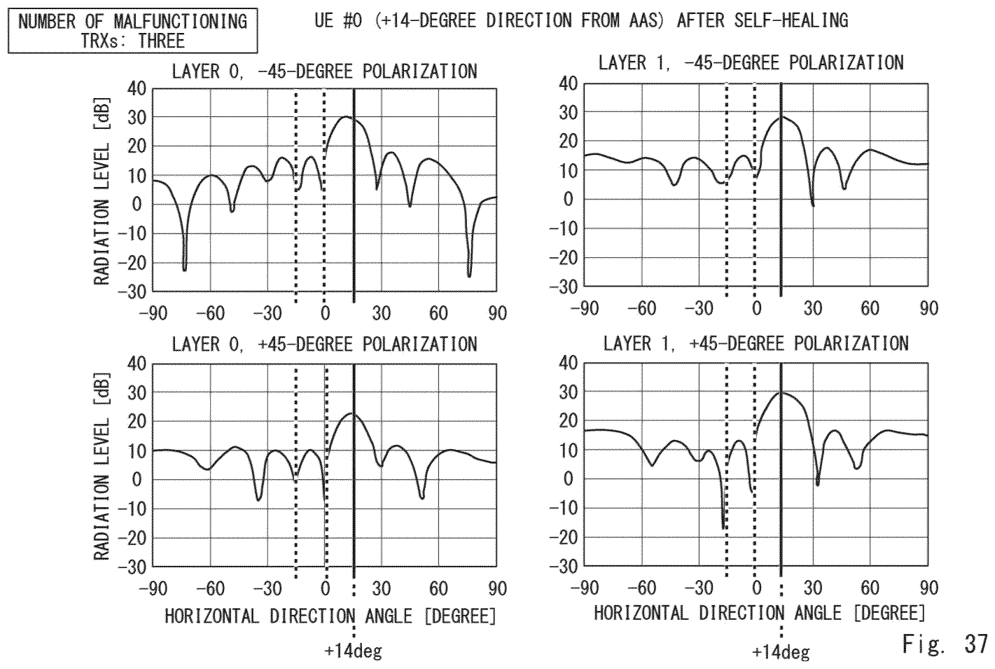

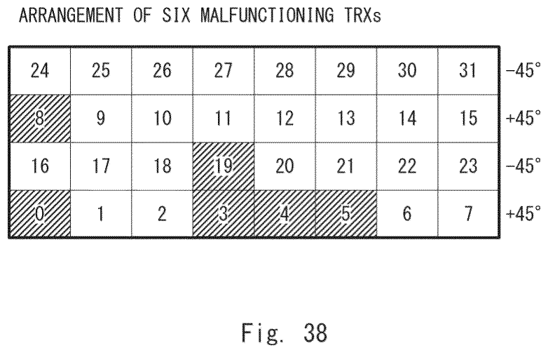

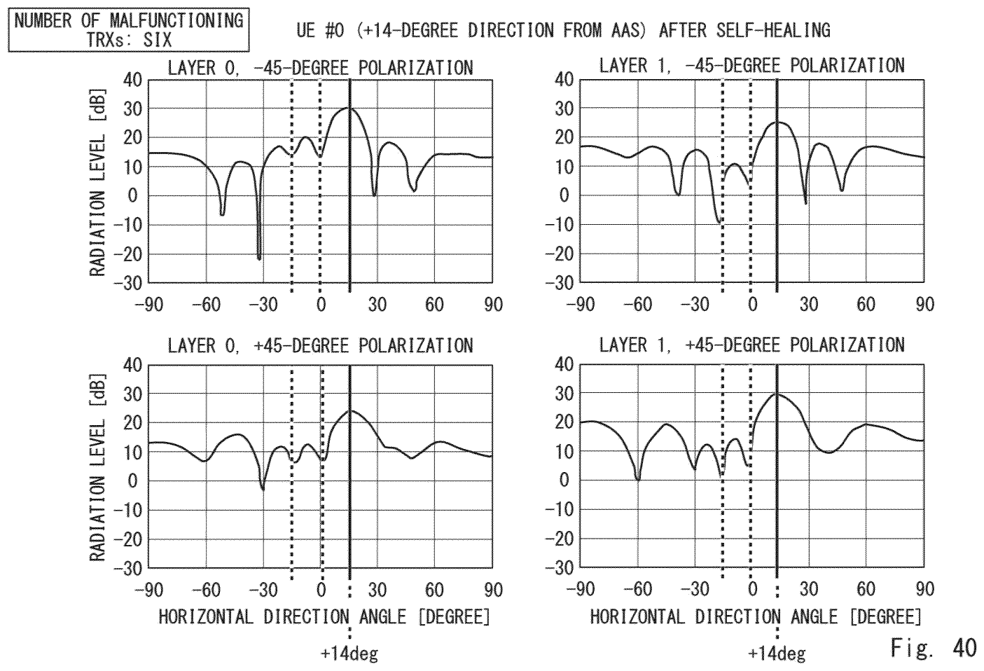

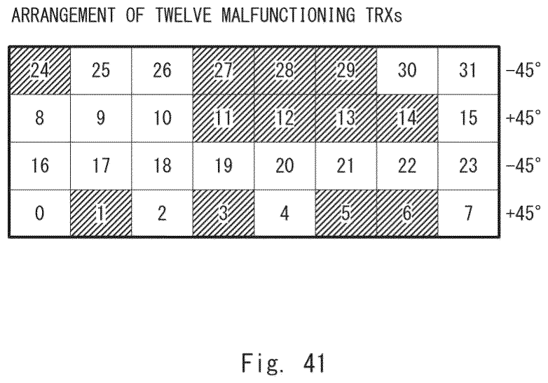

Further, FIG. 35 illustrates an example of a malfunction position that causes a worst value of the first null depth when the number of malfunctioning TRXs 31-n is three. In FIG. 35, a diagonally hatched portion indicates the malfunction position of the TRX 31-n (hereinafter, the same holds true in FIGS. 38 and 41). Further, FIG. 36 illustrates an example of the radiation pattern of the DL signal being radiated from the AAS 100 to the UE #0 in the +14-degree direction when the three UEs #0, #1, and #2 are subjected to spatial multiplexing after execution of self-healing in a state where the malfunction position of the TRX 31-n is as illustrated in FIG. 35. Further, FIG. 37 illustrates an example of the radiation pattern of the DL signal being radiated from the AAS 100 to the UE #0 after execution of self-healing in the state where the malfunction position of the TRX 31-n is as illustrated in FIG. 35. Note that, FIG. 37 illustrates an example of the radiation pattern of +45-degree polarization transmitted in the two layers (the layer 0 and the layer 1), as the radiation pattern of the DL signal being radiated to the UE #0. Further, in FIG. 37, the horizontal direction angle in the direction to the UE #1 (the 0-degree direction from the AAS 100) and the direction to the UE #2 (the −14-degree direction from the AAS 100) is indicated with auxiliary broken lines, and thereby a result of formation of the null in the directions to the UE #1 and the UE #2 is intelligibly indicated (hereinafter, the same holds true in FIGS. 40, and 43 to 46). Further, the horizontal axis and the vertical axis in FIG. 37 are similar to those in FIGS. 28 to 30 (hereinafter, the same holds true in FIGS. 40, and 43 to 46).

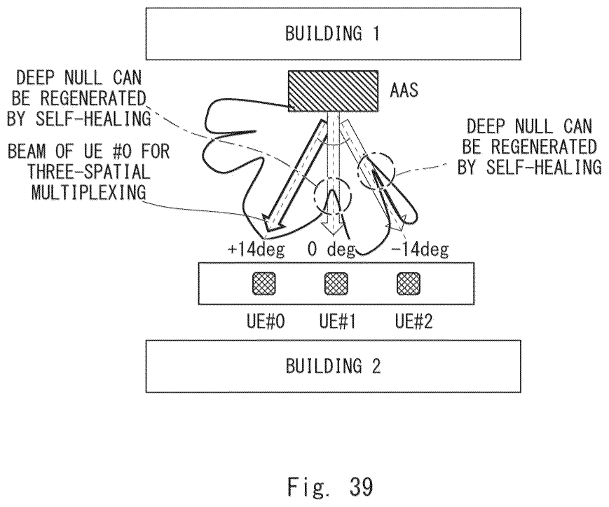

Similarly, FIG. 38 illustrates an example of a malfunction position that causes a worst value of the first null depth when the number of malfunctioning TRXs 31-n is six. Further, FIG. 39 illustrates an example of the radiation pattern of the DL signal being radiated from the AAS 100 to the UE #0 in the +14-degree direction when the three UEs #0, #1, and #2 are subjected to spatial multiplexing after execution of self-healing in a state where the malfunction position of the TRX 31-n is as illustrated in FIG. 38. Further, FIG. 40 illustrates an example of the radiation pattern of the DL signal being radiated from the AAS 100 to the UE #0 after execution of self-healing in the state where the malfunction position of the TRX 31-n is as illustrated in FIG. 38.

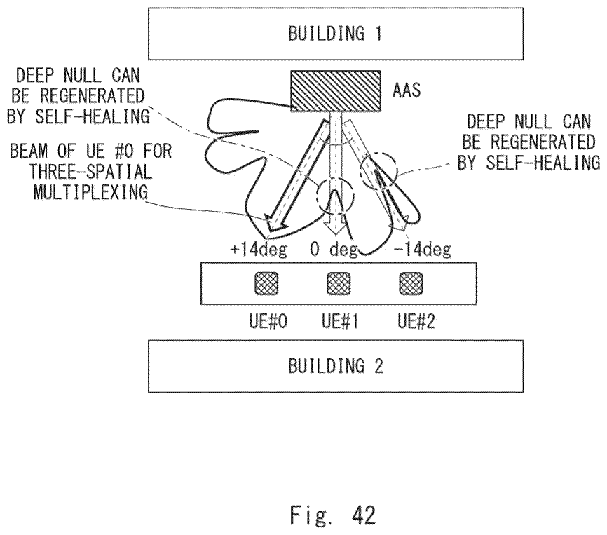

Similarly, FIG. 41 illustrates an example of a malfunction position that causes a worst value of the first null depth when the number of malfunctioning TRXs 31-n is twelve. Further, FIG. 42 illustrates an example of the radiation pattern of the DL signal being radiated from the AAS 100 to the UE #0 in the +14-degree direction when the three UEs #0, #1, and #2 are subjected to spatial multiplexing after execution of self-healing in a state where the malfunction position of the TRX 31-n is as illustrated in FIG. 41. Further, FIG. 43 illustrates an example of the radiation pattern of the DL signal being radiated from the AAS 100 to the UE #0 after execution of self-healing in the state where the malfunction position of the TRX 31-n is as illustrated in FIG. 41.

As illustrated in FIGS. 28 to 30, and 35 to 43, it can be understood that, even when the number of malfunctioning TRXs 31-n is three, six, and twelve, the null depth in the direction to the UE #1/#2 from the UE #0 is closer to the null depth when all the 32 TRXs 31-n normally function, due to an effect of self-healing. Further, as illustrated in FIGS. 31 to 34, it can be understood that, even when the number of malfunctioning TRXs 31-n is three, six, and twelve, as compared to a state before execution of self-healing where the malfunctioning TRXs 31-n are left as they are, the DL SINR and the total transmission capacity C after execution of self-healing are closer to spatial multiplexing performance when all the 32 TRXs 31-n normally function.

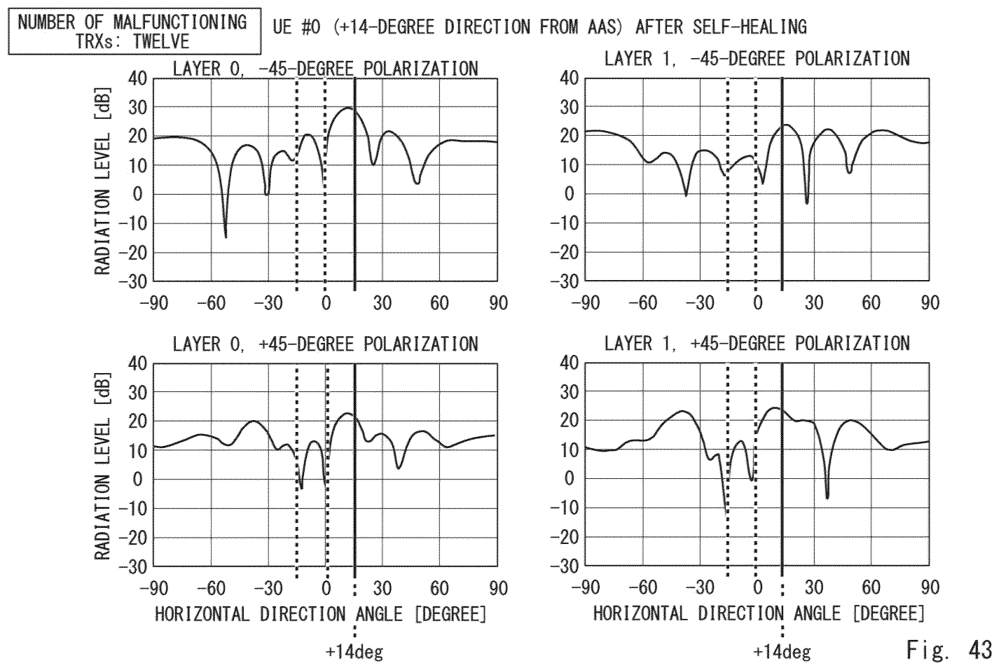

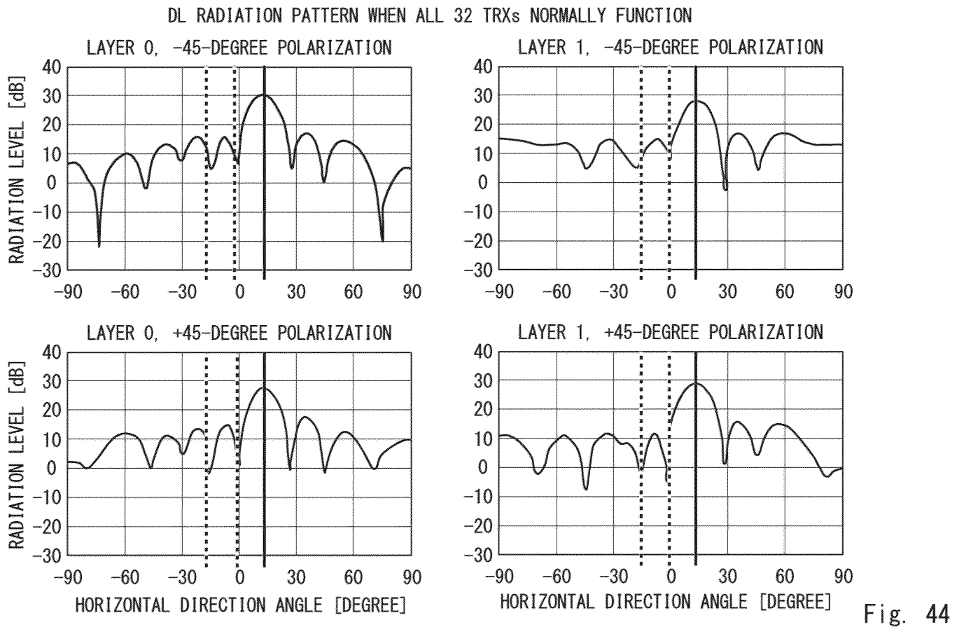

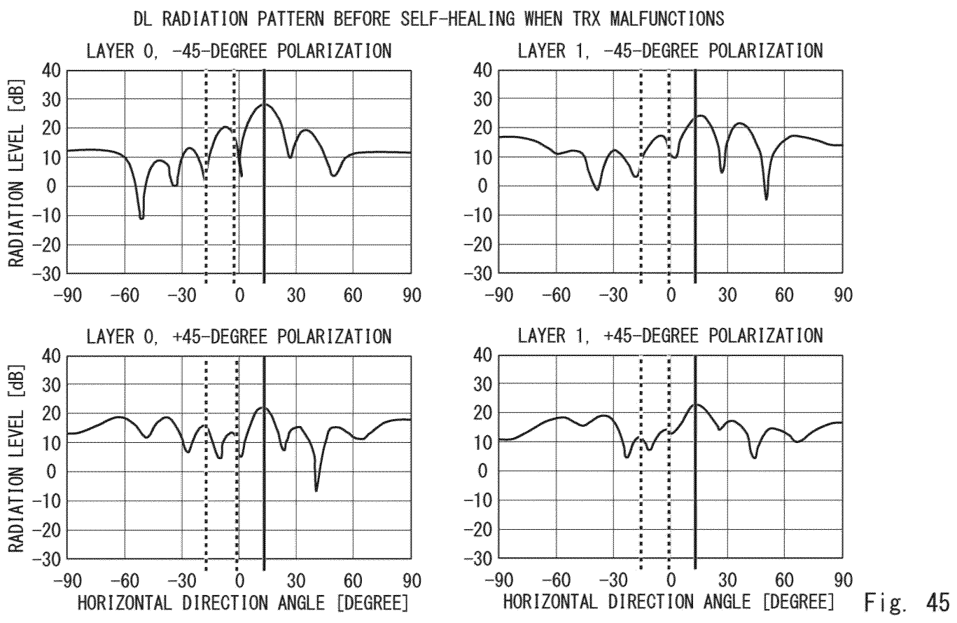

Further, in the following description, an example in which the number of malfunctioning TRXs 31-n is twelve is given as a representative example, and the radiation pattern of the DL signal being radiated from the AAS 100 to the UE #0 before and after execution of self-healing is compared with the radiation pattern of the DL signal being radiated from the AAS 100 to the UE #0 when all the 32 TRXs 31-n normally function. FIG. 44 illustrates an example in which the radiation pattern of the DL signal being radiated from the AAS 100 to the UE #0 when all the 32 TRXs 31-n normally function. FIG. 45 illustrates an example of the radiation pattern of the DL signal being radiated from the AAS 100 to the UE #0 before execution of self-healing when the number of malfunctioning TRXs 31-n is twelve. FIG. 46 illustrates an example of the radiation pattern of the DL signal being radiated from the AAS 100 to the UE #0 after self-healing when the number of malfunctioning TRXs 31-n is twelve.

As illustrated in FIGS. 44 to 46, it can be understood that, even when the 12 TRXs 31-n of all the 32 TRXs 31-n malfunction, the null depth in the direction from the UE #0 to the UE #1 and the UE #2 is improved by the effect of self-healing.

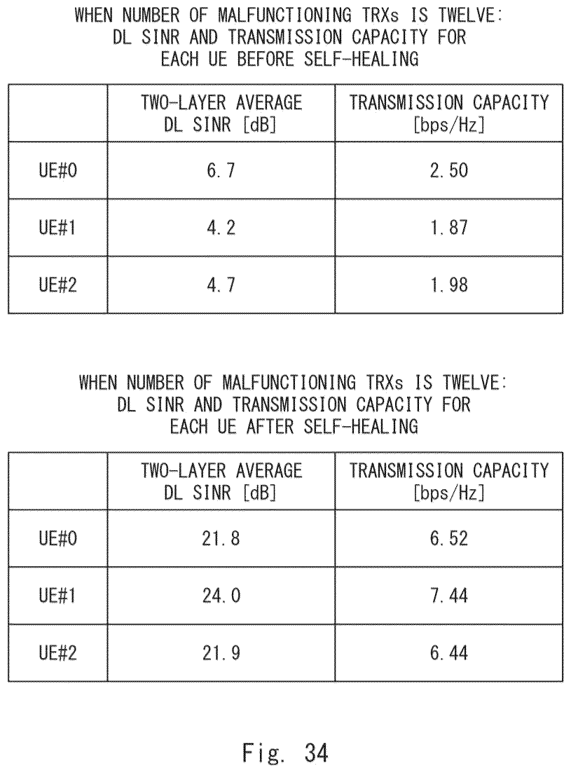

Further, although not illustrated, in a case of the UE #1 and the UE #2, the null depth in the direction to the other two UEs is also improved. Thus, as illustrated in FIGS. 31 and 34, as compared to a state before execution of self-healing where the 12 malfunctioning TRXs 31-n are left as they are, the DL SINR and the total transmission capacity C after execution of self-healing are closer to spatial multiplexing performance when all the 32 TRXs 31-n normally function, and hence it can be understood that spatial multiplexing performance is restored.

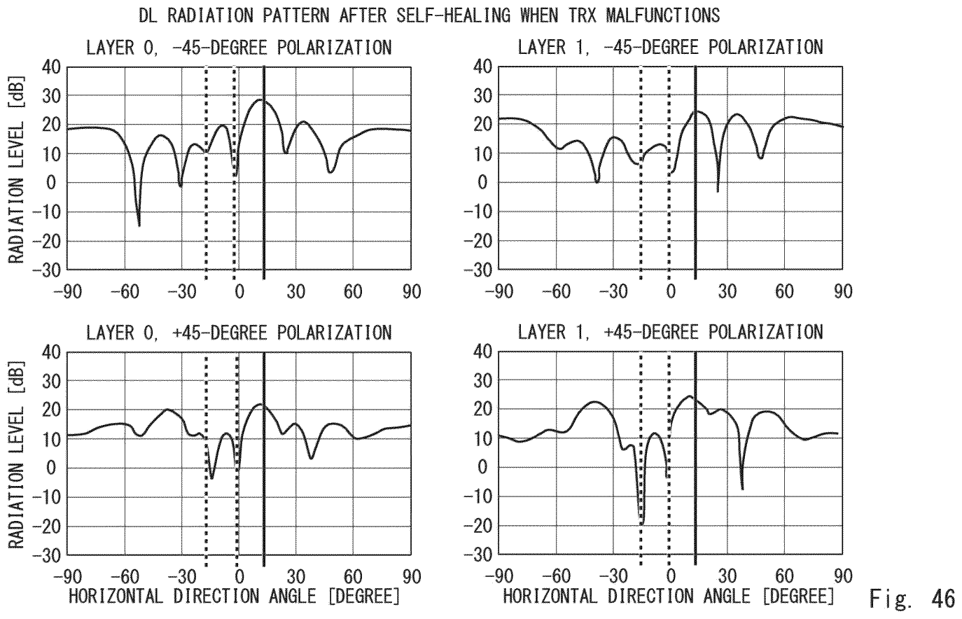

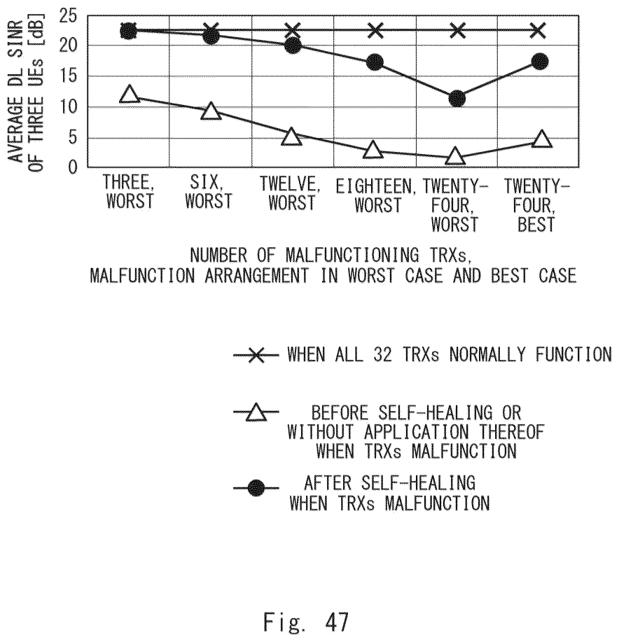

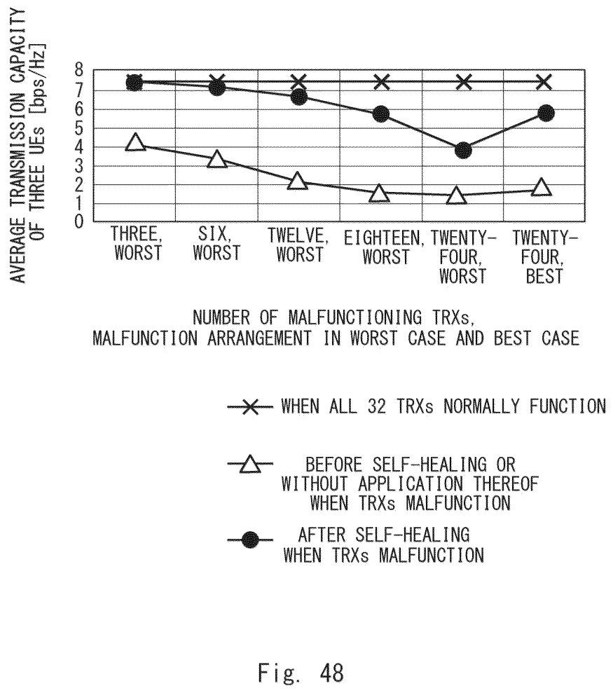

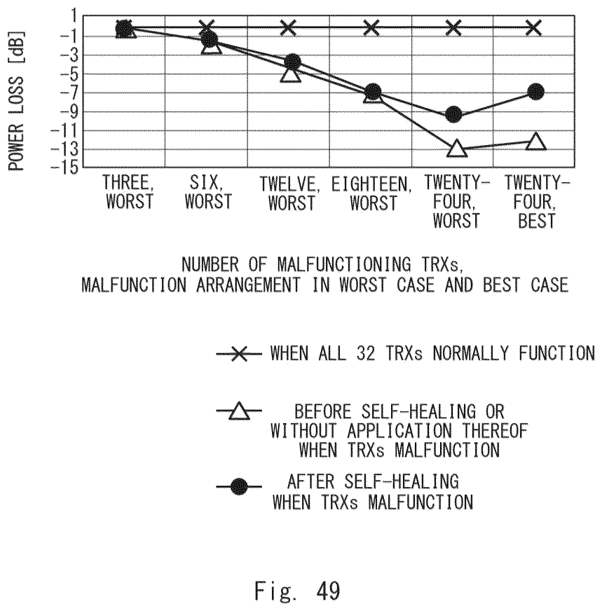

Next, an analysis is further performed, based on an analysis result of the effect of self-healing in FIGS. 28 to 46. FIG. 47 illustrates an example in which an average DL SINR of the three UEs #0, #1, and #2 before and after execution of self-healing when the number of malfunctioning TRXs 31-n is three, six, twelve, eighteen, and twenty-four is compared with the average DL SINR when all the 32 TRXs 31-n normally function. Further, FIG. 48 illustrates an example in which an average transmission capacity of the three UEs #0, #1, and #2 before and after execution of self-healing when the number of malfunctioning TRXs 31-n is three, six, twelve, eighteen, and twenty-four is compared with the average transmission capacity when all the 32 TRXs 31-n normally function. Further, FIG. 49 illustrates an example of an average power loss of the three UEs #0, #1, and #2 before and after execution of self-healing when the number of malfunctioning TRXs 31-n is three, six, twelve, eighteen, and twenty-four. Note that, the power loss is defined as a decreased amount of transmission power being consumed by forming the null by self-healing. In other words, the power loss is defined as a decreased extent of a radiation level of a main lobe from that in a case in which all the 32 TRXs 31-n normally function. Further, in FIGS. 47 to 49, when the number of malfunctioning TRXs 31-n is three, six, twelve, and eighteen, the value indicates a value at a malfunction position at which the first null depth becomes the worst value. Further, when the number of malfunctioning TRXs 31-n is twenty four, the value indicates a value at a malfunction position at which the first null depth becomes the worst value and a value at a malfunction position at which the first null depth becomes a best value.

As illustrated in FIGS. 47 and 48, it can be understood that, under a premise that the AAS 100 includes 64 antenna elements in total and the 32 TRXs 31-n in total, when the number of malfunctioning TRXs 31-n is up to approximately six, spatial multiplexing performance equivalent to that in a case in which all the 32 TRXs 31-n normally function can be achieved by the effect of self-healing. Further, when the number of malfunctioning TRXs 31-n is up to approximately twelve, the null deep in the direction to the other UEs can be formed by the effect of self-healing. Further, as illustrated in FIG. 49, when the number of malfunctioning TRXs 31-n is up to approximately twelve, the power loss due to formation of the null can be suppressed to approximately −3 dB. However, when the number of malfunctioning TRXs 31-n is equal to or more than eighteen, the power loss due to formation of the null is increased to approximately −7 dB, and thereby a DL coverage distance of the main lobe becomes 45% of that in a case in which all the 32 TRXs 31-n normally function, that is, significant deterioration further to below 50%. When this is converted into a coverage area, the coverage area is reduced to 0.2 (approximately 0.45²), in other words, 20%. In this state, even when spatial multiplexing performance can be achieved by the null, the coverage area with sufficient operational resilience cannot be acquired, and hence it can be understood that complete restoration of spatial multiplexing performance cannot be achieved, which causes an intolerable situation.

However, it can be understood that, as compared to a case in which the malfunctioning TRX 31-n is left as it is, spatial multiplexing performance is significantly restored by executing self-healing, and thereby spatial multiplexing performance can be maintained. In view of this, it can be concluded that FIG. 49 indicates effectiveness of the present disclosure.

As described above, the AAS 100 according to the present first example embodiment detects the malfunctioning TRX 31-n among the TRXs 31-n in the AAS 100. In this state, specifically, the AAS 100 executes detection of the malfunctioning TRX 31-n, based on an amplitude or a phase of the DL CAL signal being output from the TX in each of the TRXs 31-n to the CAL-TRX 51 during the DL CAL operation and an amplitude or a phase of the UL CAL signal being output from the RX in each of the TRXs 31-n to the BB unit 20 during the UL CAL operation.

Further, the AAS 100 stops transmission and reception at the malfunctioning TRX 31-n, only uses the normally functioning TRX 31-n, and then executes self-healing for reconstructing a DL BFW. In this state, specifically, the AAS 100 derives the UL transmission path matrix (=the DL transmission path matrix), based on an SRS being received from the UE, and substitutes zero for the propagation path matrix element of the malfunctioning TRX 31-n. Further, the AAS 100 subjects the UL transmission path matrix (=the DL transmission path matrix) to singular value decomposition by the ZF processing, and derives a generalized inverse matrix of a matrix consisting of right singular vectors as a new DL BFW.

Thus, even when a malfunction occurs in the TRX 31-n, the AAS 100 executes self-healing by using the normally functioning TRX 31-n other than the malfunctioning TRX 31-n, and thus the null depth in a direction to a UE other than a desired UE can be maintained. With this, spatial multiplexing performance of the AAS 100 can be maintained, and hence the AAS 100 can be continuously operated.

Further, even when a malfunction occurs in the TRX 31-n, the AAS 100 can maintain spatial multiplexing performance, and can consequently continue the operation. Thus, planned maintenance and modification for the AAS 100 can be performed, which can also contribute to reduction in capital expenditure (CAPEX) and operating expense (OPEX).

Subsequently, description is made below on modification examples of the present first example embodiment.

### (A) First Modification Example

First, a first modification example is described.

During an operation of spatial multiplexing and massive MIMO, the AAS 100 substitutes zero for the propagation path matrix element of the malfunctioning TRX 31-n, executes the ZF processing, and thus reconstructs a DL BFW. Herein, the ZF processing is processing that prioritizes maintaining the null depth.

Thus, as described with reference to FIG. 49, when the number of malfunctioning TRXs 31-n is eighteen or more, in the AAS 100, the power loss due to formation of the null is increased to approximately −7 dB, the DL coverage distance of the main lobe is significantly deteriorated further to below 50%, and the coverage area is also reduced to 20%. As a result, there is a risk that a dead zone where transmission and reception of a signal cannot be performed is generated between the AAS 100 and the UE.

In view of this, in the first modification example, the AAS 100 determines whether to execute self-healing, based on the number of malfunctioning TRXs 31-n, in order to avoid generation of a dead zone between the AAS 100 and the UE. In this state, for example, the AAS 100 uses, as a criterion for determination, a maximum rated value −3 dB (50%) being specified in 3GPP (registered trademark) or the domestic radio law.

In other words, the AAS 100 may calculate in advance a power loss due to formation of the null for each number of malfunctioning TRXs 31-n, and derives an upper limit value of the number of malfunctions, which can maintain the power loss within −3 dB, in advance as a threshold value (in the example in FIG. 49, the threshold value is 12). Further, when the number of malfunctioning TRXs 31-n is equal to or less than the threshold value, the AAS 100 determines to execute self-healing. On the other hand, when the number of malfunctioning TRXs 31-n exceeds the threshold value, the AAS 100 determines not to execute (determines to stop) self-healing. Further, in this case, the AAS 100 may issue an alarm in order to modify the AAS 100.

### (B) Second Modification Example

Next, a second modification example is described.

In the second modification example, whether to execute self-healing is determined based on the number of malfunctioning TRXs 31-n and a malfunction position thereof.

First, description is made on an example in which the number of malfunctioning TRXs 31-n is one.

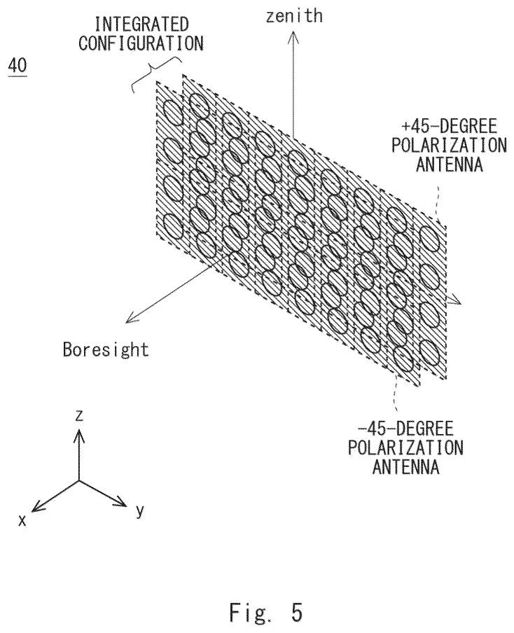

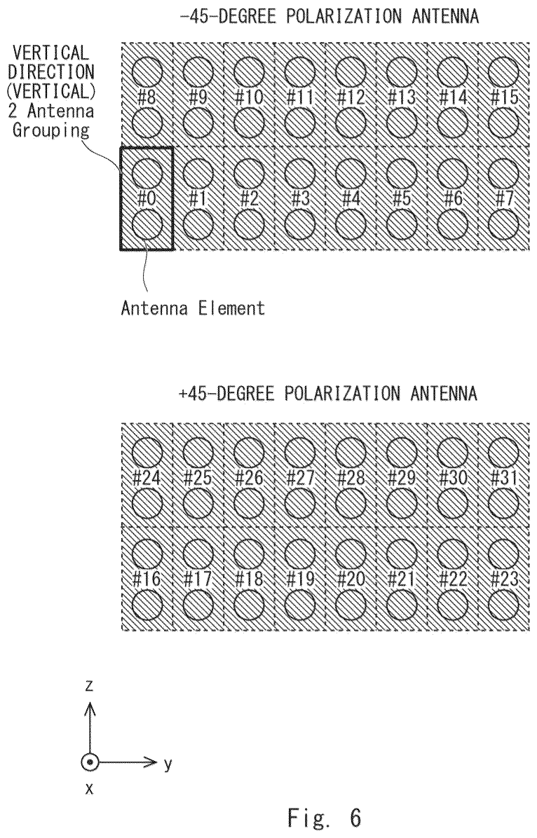

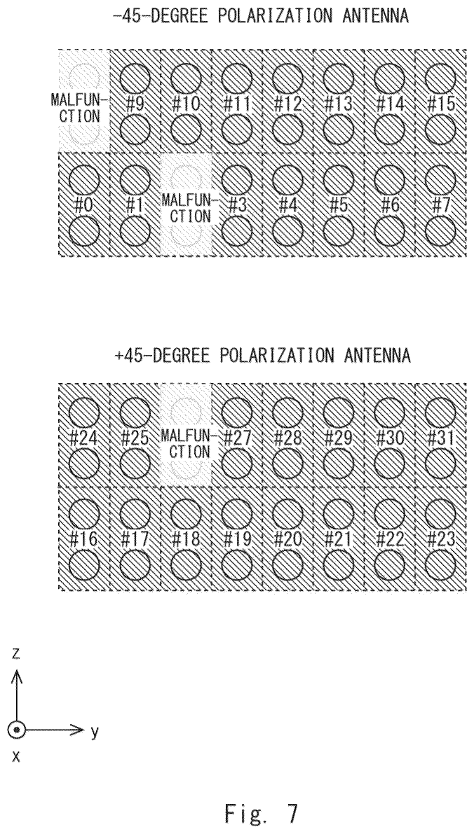

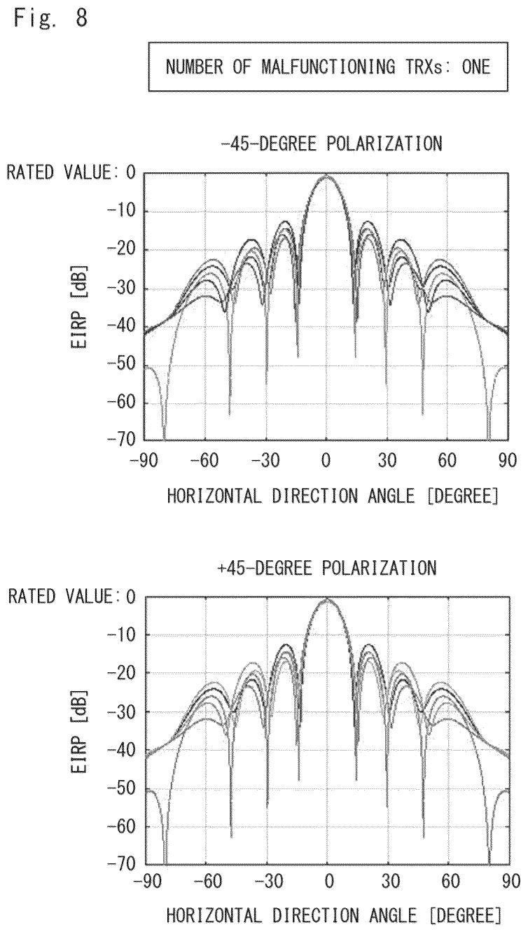

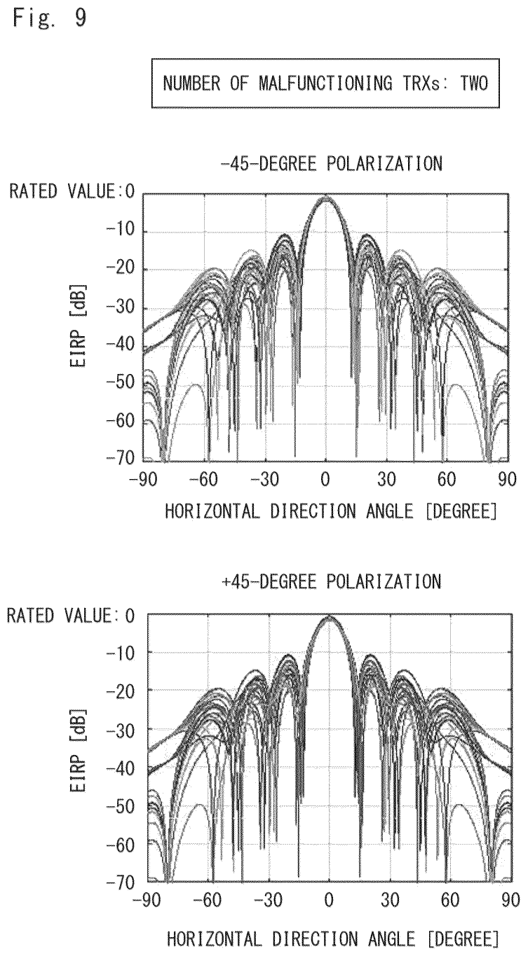

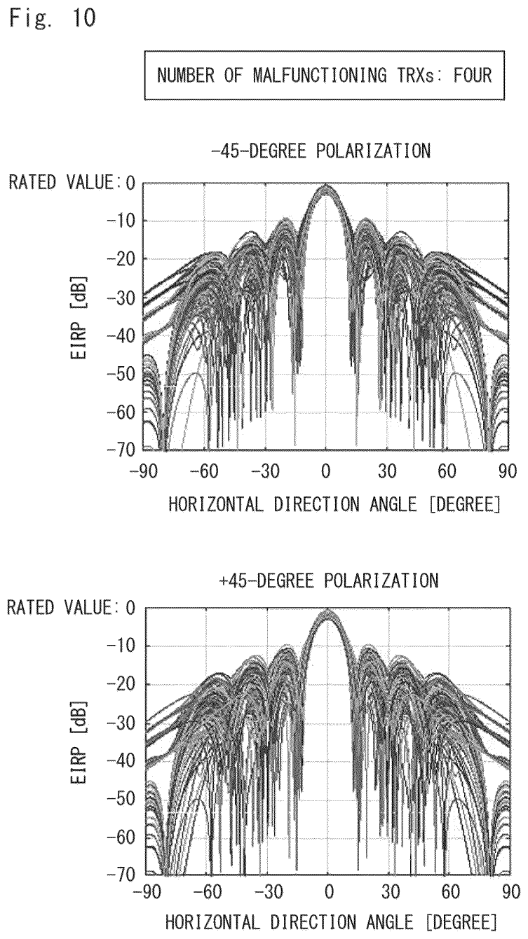

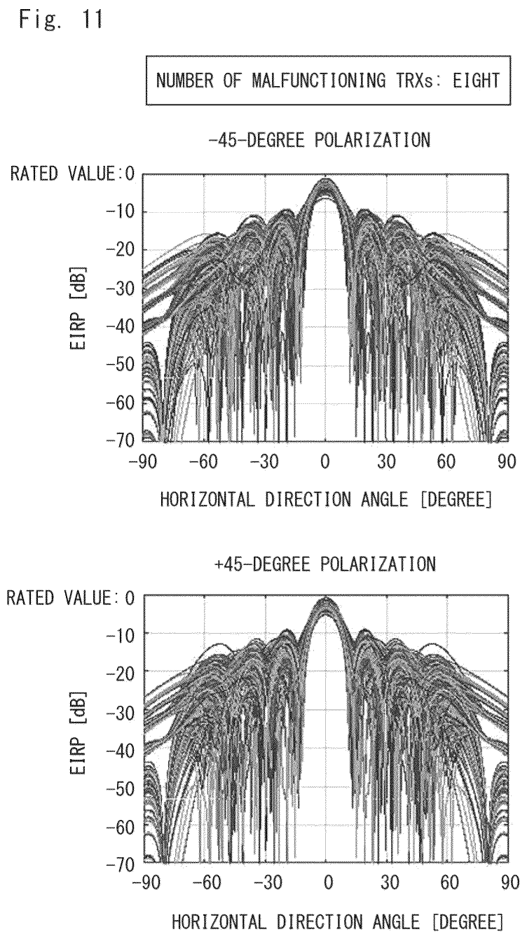

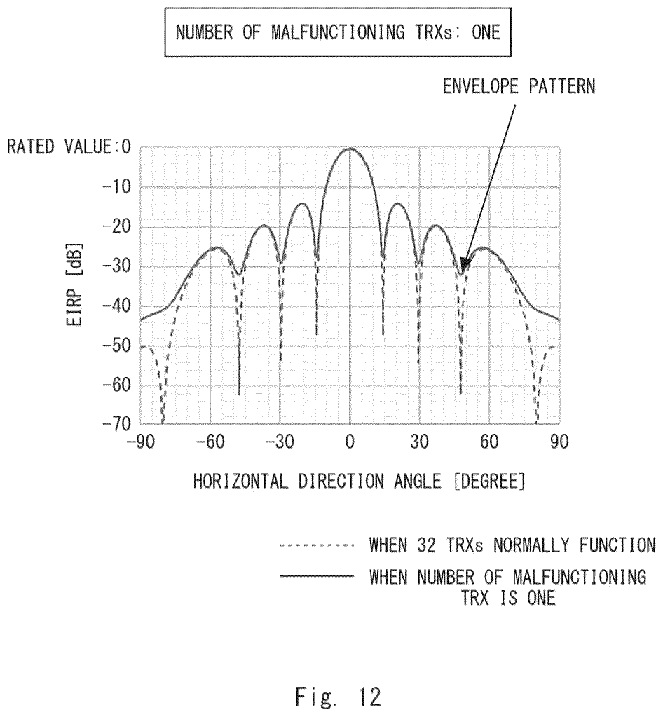

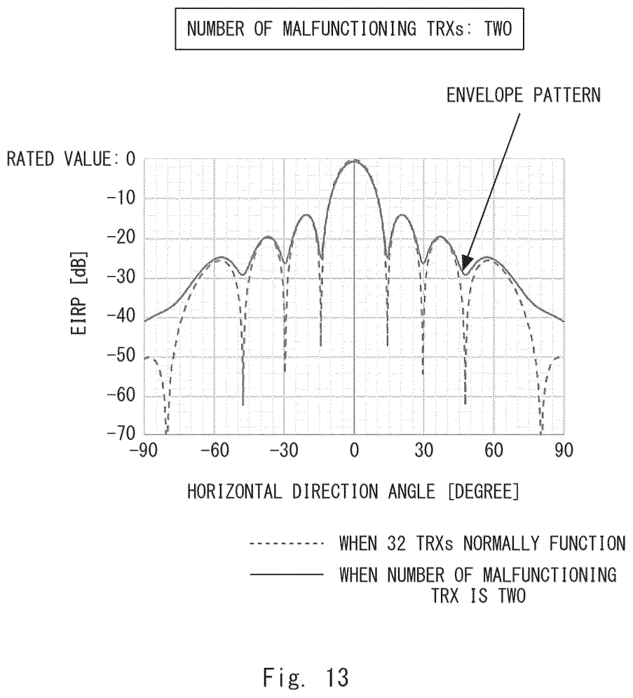

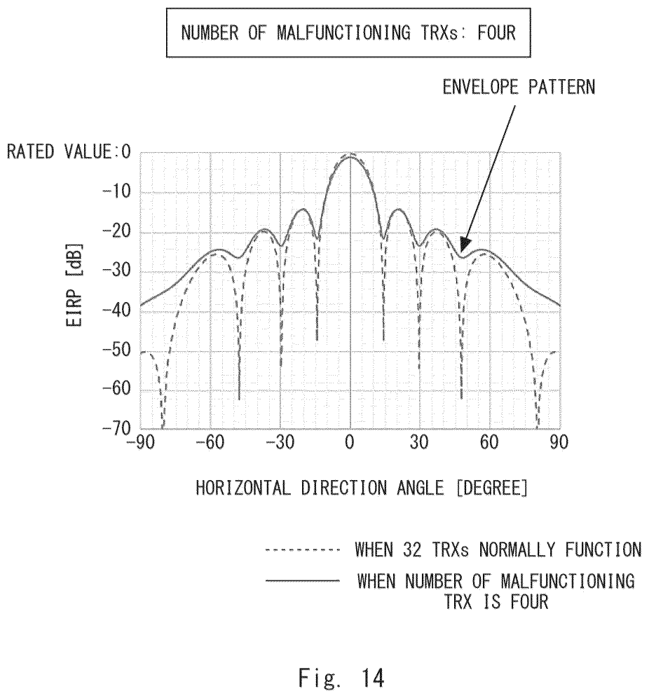

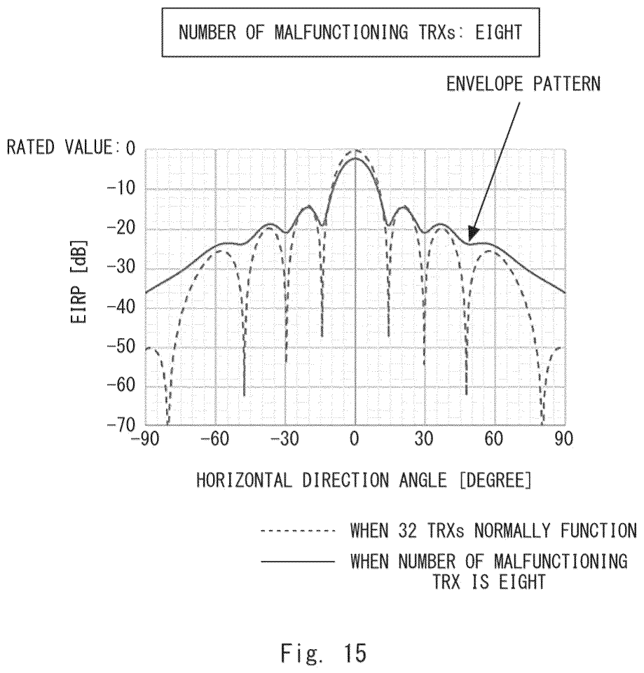

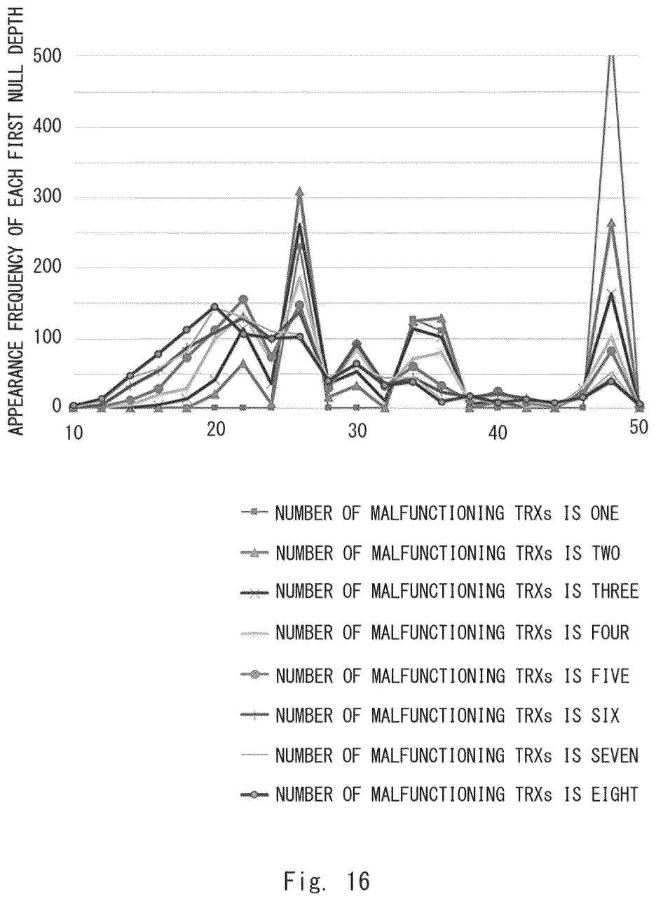

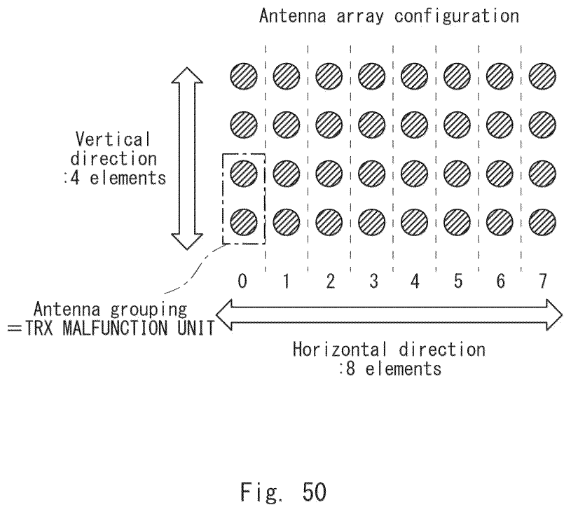

FIG. 50 illustrates an arrangement example of antenna elements configuring the antenna 40. FIG. 50 is equivalent to any of the −45-degree polarization antenna and the +45-degree polarization antenna that are illustrated in FIGS. 5 to 7.

In FIG. 50, 32 antenna elements in total including eight antennas in a horizontal direction and four antennas in a vertical direction are arranged. Further, two antenna elements in the vertical direction are grouped, and the two antenna elements being grouped are connected to one TRX 31-n. Further, a column number is given in the horizontal direction. Hereinafter, for example, a column having the column number 0 is referred to as a column 0.

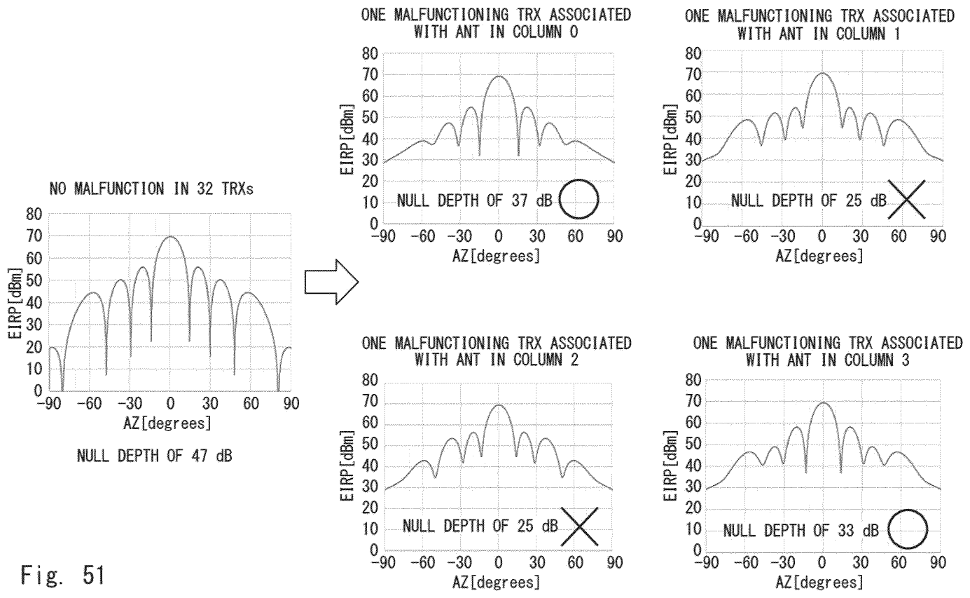

FIG. 51 illustrates an example in which the radiation pattern of the DL signal being emitted from the AAS 100 to the UE before execution of self-healing when the number of malfunctioning TRXs 31-n is one is compared, for each malfunction position, with the radiation pattern of the DL signal being emitted from the AAS 100 to the UE when all the 32 TRXs 31-n normally function. FIG. 51 illustrates the radiation pattern when one TRX 31-n connected to the antenna elements in each of the columns 0, 1, 2, and 3 malfunctions. In FIG. 51, it is assumed that the first null depth required for spatial multiplexing of 16 layers, specifically, eight UEs×two layers is 33 dB. Further, in FIG. 51, the horizontal axis indicates a horizontal direction angle as viewed from the AAS 100, and the vertical axis indicates EIRP.

As illustrated in FIG. 51, when one TRX 31-n connected to the antenna elements in each of the columns 0 and 3 malfunctions, the first null depth (33 dB) required for spatial multiplexing of 16 layers can be maintained even before execution of self-healing. In contrast, when one TRX 31-n connected to the antenna elements in each of the columns 1 and 2 malfunctions, the first null depth (33 dB) required for spatial multiplexing of 16 layers cannot be maintained.

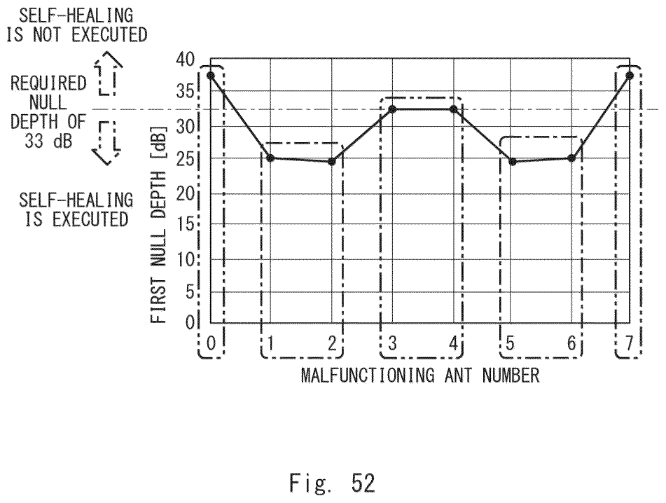

FIG. 52 illustrates an example in which the horizontal axis indicates the column number of a malfunction position and the vertical axis indicates the first null depth before execution of self-healing for each column number when the number of malfunctioning TRXs 31-n is one.

As illustrated in FIG. 52, when one TRX 31-n connected to the antenna elements in each of the columns 0, 3, 4, and 7 malfunctions, the first null depth (33 dB) required for spatial multiplexing of 16 layers can be maintained. In other words, in this case, stable spatial multiplexing performance can be maintained without executing self-healing.

In contrast, when one TRX 31-n connected to the antenna elements in each of the columns 1, 2, 5, and 6 malfunctions, the first null depth (33 dB) required for spatial multiplexing of 16 layers cannot be maintained. Thus, it is required to improve spatial multiplexing performance by executing self-healing.

Thus, when the number of malfunctioning TRXs 31-n is one, the AAS 100 stores the positions connected to the antenna elements in each of the columns 1, 2, 5, and 6 in advance as a malfunction position at which self-healing is executed. Further, in a case in which the number of malfunctioning TRXs 31-n is one, the AAS 100 determines to execute self-healing when the malfunction position of the TRX 31-n matches with the position being stored in advance, and determines not to execute self-healing in other cases.

Alternatively, when the number of malfunctioning TRXs 31-n is one, the AAS 100 stores the positions connected to the antenna elements in each of the columns 0, 3, 4, and 7 in advance as a malfunction position at which self-healing is not executed. Further, in a case in which the number of malfunctioning TRXs 31-n is one, the AAS 100 determines not to execute self-healing when the malfunction position of the TRX 31-n matches with any of the positions being stored in advance, and determines to execute self-healing in other cases.

Next, description is made on an example in which the number of malfunctioning TRXs 31-n is two.

Herein, when the number of malfunctioning TRXs 31-n is two, 1,000 malfunction positions of the TRX 31-n are randomly selected, and the first null depth before execution of self-healing is calculated at each of the 1,000 malfunction positions. Further, in order from the shallowest first null depth, 10 malfunction position samples are extracted. It is assumed that, of the 10 samples, the first null depth at the malfunction position in the sample number 1 is the shallowest, and the first null depth is deeper as the sample number is larger.

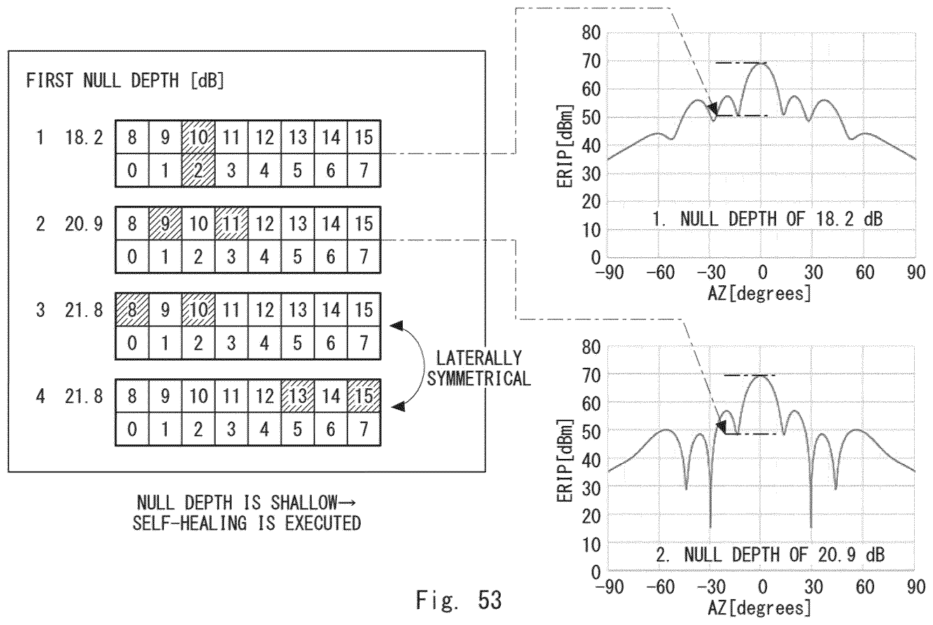

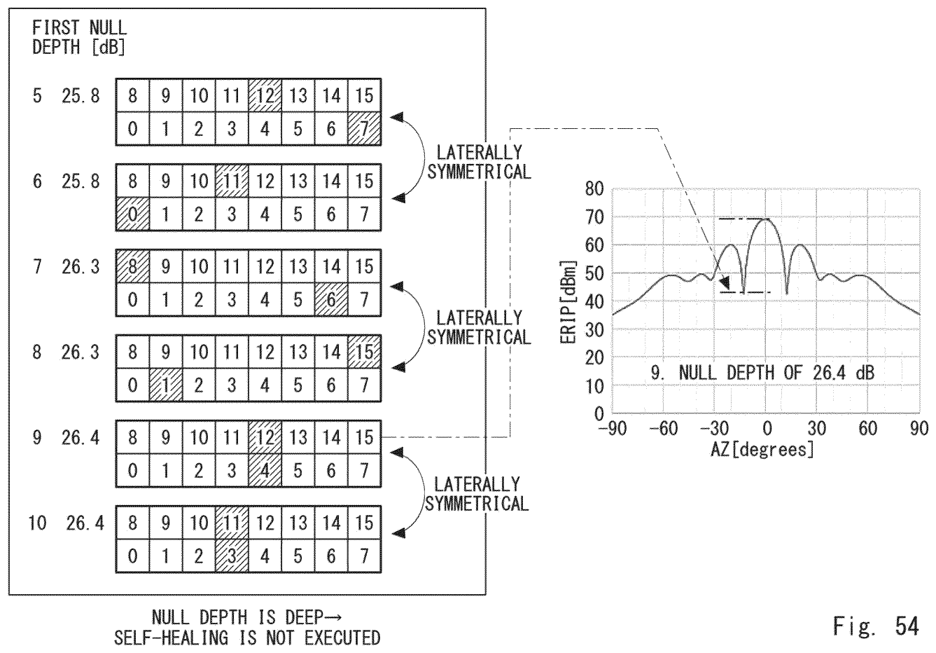

FIG. 53 illustrates an example of the first null depth before execution of self-healing for each of the malfunction positions in the sample numbers 1 to 4 when the number of malfunctioning TRXs 31-n is two. Further, FIG. 53 also illustrates an example of the radiation pattern of the DL signal when the malfunction positions is the sample numbers 1 and 2. Further, FIG. 54 illustrates an example of the first null depth before execution of self-healing for each of the malfunction positions in the sample numbers 5 to 10 when the number of malfunctioning TRXs 31-n is two. Further, FIG. 54 also illustrates an example of the radiation pattern of the DL signal when the malfunction position is the sample number 9. Note that, in FIGS. 53 and 54, a diagonally hatched portion indicates the malfunction position of the TRX 31-n. Further, the horizontal axis and the vertical axis for the radiation pattern of the DL signal are similar to those in FIG. 51.

As illustrated in FIG. 53, in the sample numbers 1 to 4, the TRXs 31-n connected to the antenna elements in the columns 0, 1, 2, 5, 6, and 7 shifted to right or left from the columns 3 and 4 near the center in the horizontal direction malfunction, and the positions of the malfunctioning TRXs 31-n are biased to the right or the left. Further, in the sample numbers 1 to 4, the first null depth is shallow, and it is required to improve spatial multiplexing performance by executing self-healing.

On the other hand, in the sample numbers 5 to 10, the TRXs 31-n connected to the antenna elements in the columns 3 and 4 near the center in the horizontal direction malfunction, or the positions of the malfunctioning TRXs 31-n are not biased to the right or the left. Further, in the sample numbers 5 to 10, the first null depth is deeper than that in the sample numbers 1 to 4, and stable spatial multiplexing performance can be maintained.

Thus, when the number of malfunctioning TRXs 31-n is two, the AAS 100 stores in advance the malfunction positions in the sample numbers 1 to 4 as a malfunction position at which self-healing is executed. Further, when the number of malfunctioning TRXs 31-n is two, the AAS 100 determines to execute self-healing when the malfunction position of the TRX 31-n matches with any of the positions being stored in advance, and determines not to execute self-healing in other cases.

### (C) Third Modification Example

Next, a third modification example is described.

In the third modification example, some of the processing executed by the AAS 100 is executed by a DU 200.

The AAS 100 detects the malfunctioning TRX 31-n, and notifies the DU 200 of the number of malfunctioning TRXs 31-n, the malfunction position, and the like via a multi-core multi-mode optical fiber (optical front haul). Further, the AAS 100 transfers an SRS being received from the UE to the DU 200 via the multi-core multi-mode optical fiber (optical front haul).

The DU 200 stops transmission and reception at the malfunctioning TRX 31-n, only uses the normally functioning TRX 31-n, and then executes self-healing for reconstructing a DL BFW. In this state, specifically, the DU 200 derives the UL transmission path matrix (=the DL transmission path matrix), based on the SRS being received from the UE, and substitutes zero for the propagation path matrix element of the malfunctioning TRX 31-n. Further, the DU 200 subjects the UL transmission path matrix (=the DL transmission path matrix) to singular value decomposition by the ZF processing, and derives a generalized inverse matrix of a matrix consisting of right singular vectors as a new DL BFW.

The DU 200 multiplies the DL BFW being reconstructed to the DL signal being finally emitted from the antenna 40 in the AAS 100 to the two layers of each of the UEs, and transmits the DL signal to which the DL BFW is multiplied to the AAS 100 via the multi-core multi-mode optical fiber (optical front haul).

Alternatively, the DU 200 notifies the AAS 100 of the DL BFW being reconstructed via the multi-core multi-mode optical fiber (optical front haul). The AAS 100 multiplies the DL BFW being reconstructed to the DL signal being finally emitted from the antenna 40 to the two layers of each of the UEs.

### Second Example Embodiment

A second example embodiment is equivalent to an example embodiment that schematically illustrates the first example embodiment described above.

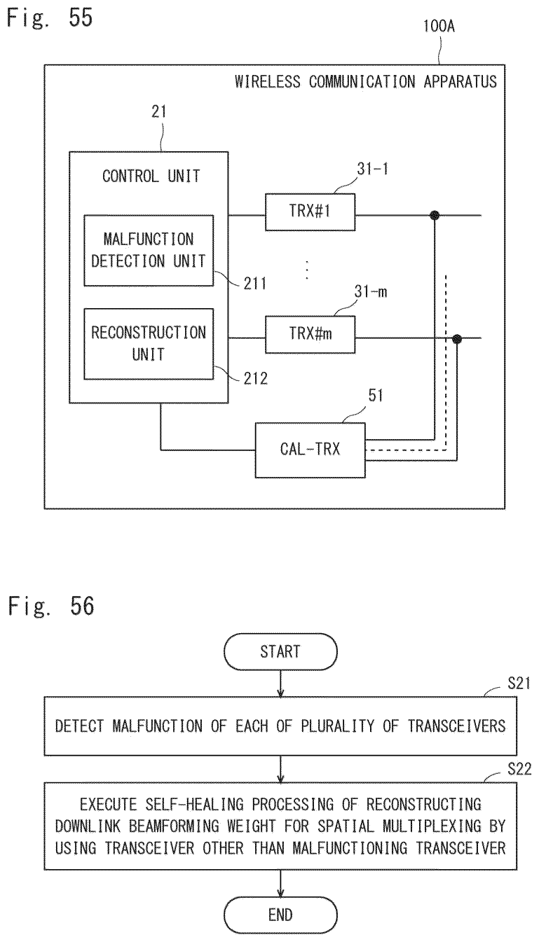

First, a configuration of a wireless communication apparatus 100A according to the present second example embodiment is described. FIG. 55 illustrates a circuit configuration example of the wireless communication apparatus 100A according to the present second example embodiment. Note that, the wireless communication apparatus 100A is equivalent to the AAS 100 according to the first example embodiment described above. Further, in FIG. 55, it is assumed that the wireless communication apparatus 100A is used as a base station.

As illustrated in FIG. 55, the wireless communication apparatus 100A according to the present second example embodiment includes a control unit 21, m (m is an integer equal to or greater than 2) transceivers (TRX) 31-1 to 31-m, and a calibration transceiver (CAL-TRX) 51. Note that, hereinafter, when description is made without specifying the TRXs 31-1 to 31-m from one another, each of the TRXs 31-1 to 31-m is referred to as a TRX 31-n (n=1, . . . , m) as appropriate.

The control unit 21 is equivalent to the BB unit 20 in the first example embodiment described above.

The control unit 21 controls a downlink calibration (DL CAL) operation and an uplink calibration (UL CAL) operation.

During the DL CAL operation, a downlink calibration (DL CAL) signal is output from the control unit 21 to each of the m TRXs 31-n, is output from each of the m TRXs 31-n to the CAL-TRX 51, and is output from the CAL-TRX 51 to the control unit 21.

During the UL CAL operation, an uplink calibration (UL CAL) signal is output from the control unit 21 to the CAL-TRX 51, is output from the CAL-TRX 51 to each of the m TRXs 31-n, and is output from each of the m TRXs 31-n to the control unit 21.

The control unit 21 includes a malfunction detection unit 211 and a reconstruction unit 212.

The malfunction detection unit 211 detects a malfunction of each of the m TRXs 31-n, based on the DL CAL signal being output from each of the m TRXs 31-n to the CAL-TRX 51 during the DL CAL operation and the UL CAL signal being output from each of the m TRXs 31-n to the control unit 21 during the UL CAL operation.

The reconstruction unit 212 executes self-healing processing of reconstructing a downlink beam forming weight (DL BFW) for spatial multiplexing by using the TRX 31-n other than the malfunctioning TRX 31-n among the m TRXs 31-n.

Herein, an operation flow of the wireless communication apparatus 100A according to the present second example embodiment is described. FIG. 56 illustrates an example of a schematic operation flow of the wireless communication apparatus 100A according to the present second example embodiment.

As illustrated in FIG. 56, the malfunction detection unit 211 detects a malfunction of each of the m TRXs 31-n, based on the DL CAL signal being output from each of the m TRXs 31-n to the CAL-TRX 51 during the DL CAL operation and the UL CAL signal being output from each of the m TRXs 31-n to the control unit 21 during the UL CAL operation (step S21).

The reconstruction unit 212 executes the self-healing processing of reconstructing a DL BFW for spatial multiplexing by using the TRX 31-n other than the malfunctioning TRX 31-n among the m TRXs 31-n (step S22).

Thus, even when a malfunction occurs in the TRX 31-n, the wireless communication apparatus 100A executes the self-healing processing by using the TRX 31-n other than the malfunctioning TRX 31-n, and thus a DL BFW for spatial multiplexing can be reconstructed. With this, the wireless communication apparatus 100A can maintain a null depth in a direction to a UE other than a desired UE, and hence can maintain spatial multiplexing performance.

Note that, the malfunction detection unit 211 may detect a malfunction of each of the m TRXs 31-n, based on a phase or an amplitude of the DL CAL signal being output from each of the m TRXs 31-n to the CAL-TRX 51 during the DL CAL operation and a phase or an amplitude of the UL CAL signal being output from each of the m TRXs 31-n to the control unit 21 during the UL CAL operation. For example, the malfunction detection unit 211 may calculate an average value of the phase or the amplitude of the DL CAL signals (or the UL CAL signals) being output from the m TRXs 31-n, and determine that the TRX 31-n having a difference from the average value, which is equal to or greater than a threshold value, malfunctions.

Further, the reconstruction unit 212 may substitute zero for a matrix element of the malfunctioning TRX 31-n among matrix elements of a propagation path matrix representing a propagation path to a terminal such as a UE, execute zero-forcing (ZF) processing by using the propagation path matrix, and thus reconstruct a DL BFW for spatial multiplexing.

Further, the reconstruction unit 212 may execute singular value decomposition for the propagation path matrix in which zero is substituted for the matrix element of the malfunctioning TRX 31-n, during the zero-forcing processing, and derive, as a DL BFW for spatial multiplexing being reconstructed, a generalized inverse matrix of a matrix consisting of right singular vectors acquired by singular value decomposition.

Further, the wireless communication apparatus 100A may further includes a first determination unit that determines whether to execute the self-healing processing, based on the number of malfunctioning TRXs 31-n. In this case, when the first determination unit described above determines that execution is possible, the reconstruction unit 212 executes the self-healing processing.

Further, the first determination unit described above may calculate in advance a power loss indicating a difference between transmission power of a transmission signal at a time of executing spatial multiplexing in a state where all the m TRXs 31-n normally function, and transmission power of a transmission signal at a time of executing spatial multiplexing with a DL BFW for spatial multiplexing, which is reconstructed by the self-healing processing, for each number of malfunctioning TRXs 31-n. Further, the first determination unit described above may set a threshold value of the number of malfunctioning TRXs 31-n in advance, based on the power loss for each number of malfunctioning TRXs 31-n. Further, the first determination unit described above may determine whether to execute the self-healing processing, based on a comparison result between the number of malfunctioning TRXs 31-n and the threshold value.

Further, the first determination unit described above may set an upper limit value of the number of malfunctioning TRXs 31-n, which can maintain the power loss within a predetermined value, in advance as a threshold value.

Further, the wireless communication apparatus 100A may further include a second determination unit that determines whether to execute the self-healing processing, based on the number of malfunctioning TRXs 31-n and a malfunction position thereof. In this case, when the second determination unit described above determines that execution is possible, the reconstruction unit 212 executes the self-healing processing.

### Third Example Embodiment

A present third example embodiment is equivalent to an example embodiment in which some of constituent elements, which is included in the wireless communication apparatus 100A according to the second example embodiment described above, is provided to another wireless communication apparatus.

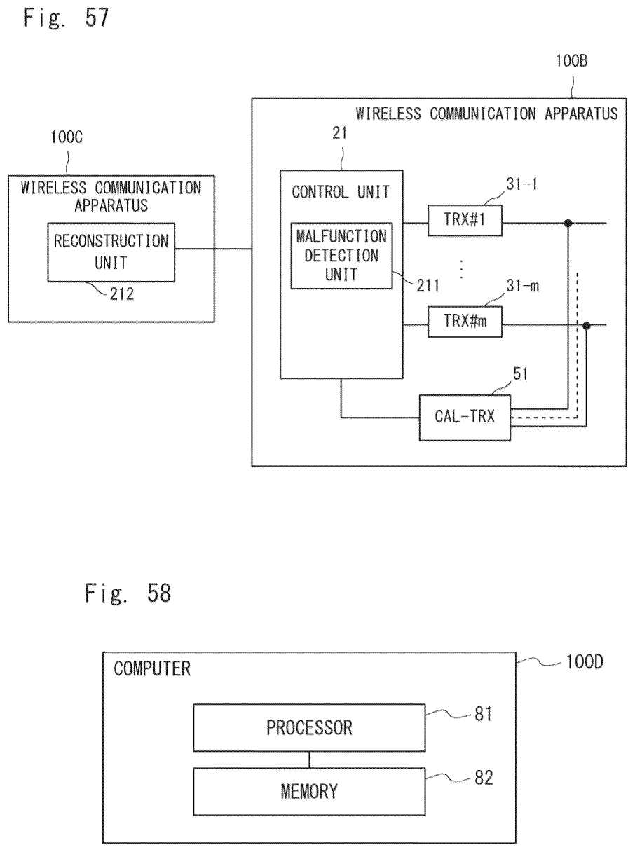

First, a configuration of a wireless communication system according to the present third example embodiment is described. FIG. 57 illustrates a circuit configuration example of the wireless communication system according to the present third example embodiment.

As illustrated in FIG. 57, the wireless communication system according to the present third example embodiment includes a first wireless communication apparatus 100B and a second wireless communication apparatus 100C. Note that, the first wireless communication apparatus 100B is equivalent to the AAS 100 according to the first example embodiment described above, and the second wireless communication apparatus 100C is equivalent to the DU 200 according to the first example embodiment described above.

As compared to the wireless communication apparatus 100A according to the second example embodiment described above, the reconstruction unit 212 is removed from the first wireless communication apparatus 100B.

The second wireless communication apparatus 100C includes the reconstruction unit 212 described above.

In the present third example embodiment, a malfunction detection unit 211 in the first wireless communication apparatus 100B detects a malfunctioning TRX 31-n, and notifies the reconstruction unit 212 in the second wireless communication apparatus 100C of the number of malfunctioning TRXs 31-n, a malfunction position thereof, and the like. The reconstruction unit 212 in the second wireless communication apparatus 100C executes self-healing processing similar to that in the second example embodiment described above, based on the number of malfunctioning TRXs 31-n, the malfunction position thereof, and the like.

As described above, while the present third example embodiment is different from the second example embodiment described above in an installation position of the reconstruction unit 212, a basic operation and an effect are similar to those in the second example embodiment described above. Thus, description for the operation and the effect of the present third example embodiment is omitted.

While the present disclosure has been particularly described with reference to example embodiments thereof, the present disclosure is not limited to these example embodiments. It will be understood by those of ordinary skill in the art that various changes in form and details may be made therein without departing from the spirit and scope of the present disclosure as defined by the claims.

For example, each of the example embodiments described above may be combined with other example embodiments as appropriate.

Further, some of the functions of the wireless communication apparatus (including the AAS and the DU) according to the present disclosure can also be achieved by causing a processor such as a central processing unit (CPU) to execute a program.

FIG. 58 illustrates a hardware configuration example of a computer 100D that achieves some of the functions of the wireless communication apparatus according to the present disclosure.

As illustrated in FIG. 58, the computer 100D includes a processor 81 and a memory 82

For example, the processor 81 may be a micro processor, a CPU, or a micro processing unit (MPU). The processor 81 may include a plurality of processors.

The memory 82 is configured by a combination of a volatile memory and a non-volatile memory. The memory 82 may include a storage arranged away from the processor 81. In this case, the processor 81 may access to the memory 82 via an input (I)/output (O) interface omitted in illustration.

The memory 82 stores a program. The program includes an instruction group (or a software code) for causing the computer 100D to execute some of the functions of the wireless communication apparatus according to each of the example embodiments described above when the program is read by the computer 100D. The processor 81 may achieve the above-mentioned constituent elements of the wireless communication apparatus by reading and executing the program stored in the memory 82. Further, the above-mentioned constituent element including a storage function of the wireless communication apparatus may be achieved by the memory 82.

Further, the above-mentioned program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Further, the whole or part of the example embodiments disclosed above can be described as, but not limited to, the following supplementary notes.

### (Supplementary Note 1)

A wireless communication apparatus including:
a plurality of transceivers;
a calibration transceiver; and
a first controller,
wherein the first controller
   detects a malfunction of each of the plurality of transceivers, based on a downlink calibration signal being output from each of the plurality of transceivers to the calibration transceiver during a downlink calibration operation and an uplink calibration signal being output from each of the plurality of transceivers to the first controller during an uplink calibration operation, and
   executes self-healing processing of reconstructing a downlink beam forming weight for spatial multiplexing by using the transceiver other than the malfunctioning transceiver among the plurality of transceivers.

### (Supplementary Note 2)

The wireless communication apparatus according to supplementary note 1, wherein the first controller detects a malfunction of each of the plurality of transceivers, based on a phase or an amplitude of the downlink calibration signal that are output from each of the plurality of transceivers and a phase or an amplitude of the uplink calibration signal.

### (Supplementary Note 3)

The wireless communication apparatus according to supplementary note 1, wherein the first controller
substitutes zero for a matric element of the malfunctioning transceiver among matrix elements of a propagation path matrix representing a propagation path to a terminal, and
reconstructs the downlink beam forming weight for spatial multiplexing by executing zero-forcing processing by using the propagation path matrix in which zero is substituted for a matrix element of the malfunctioning transceiver.

### (Supplementary Note 4)

The wireless communication apparatus according to supplementary note 3, wherein the first controller executes singular value decomposition for the propagation path matrix in which zero is substituted for a matrix element of the malfunctioning transceiver, during the zero-forcing processing, and derives, as the downlink beam forming weight for spatial multiplexing to be reconstructed, a generalized inverse matrix of a matrix consisting of right singular vectors acquired by singular value decomposition.

### (Supplementary Note 5)

The wireless communication apparatus according to supplementary note 1, further including a second controller configured to determine whether to execute the self-healing processing, based on the number of malfunctioning transceivers.

### (Supplementary Note 6)

The wireless communication apparatus according to supplementary note 5, wherein the second controller
calculates a power loss indicating a difference between transmission power of a transmission signal at a time of executing spatial multiplexing in a state where all the plurality of transceivers normally function and transmission power of a transmission signal at a time of executing spatial multiplexing with a downlink beam forming weight for spatial multiplexing being reconstructed by the self-healing processing, for each number of malfunctioning transceivers,
sets a threshold value of the number of malfunctioning transceivers in advance, based on the power loss for each number of malfunctioning transceivers, and
determines whether to execute the self-healing processing, based on a comparison result between the number of malfunctioning transceivers and the threshold value.

### (Supplementary Note 7)

The wireless communication apparatus according to supplementary note 6, wherein the second controller sets an upper limit value of the number of malfunctioning transceivers, which can maintain the power loss to within a predetermined value, in advance as the threshold value.

### (Supplementary Note 8)

The wireless communication apparatus according to supplementary note 1, further including a third controller configure to determine whether to execute the self-healing processing, based on the number of malfunctioning transceivers and a malfunction position of the transceiver.

### (Supplementary Note 9)

A wireless communication method performed by a wireless communication apparatus including a plurality of transceivers, a calibration transceiver, and a controller, the wireless communication method including:
a malfunction detection step of detecting a malfunction of each of the plurality of transceivers, based on a downlink calibration signal being output from each of the plurality of transceivers to the calibration transceiver during a downlink calibration operation and an uplink calibration signal being output from each of the plurality of transceivers to the controller during an uplink calibration operation; and
a reconstruction step of executing self-healing processing of reconstructing a downlink beam forming weight for spatial multiplexing by using the transceiver other than the malfunctioning transceiver among the plurality of transceivers.

### (Supplementary Note 10)

A wireless communication system including:
a first wireless communication apparatus; and
a second wireless communication apparatus, wherein
the first wireless communication apparatus includes
   a plurality of transceivers,
   a calibration transceiver, and
   a controller,
the controller detects a malfunction of each of the plurality of transceivers, based on a downlink calibration signal being output from each of the plurality of transceivers to the calibration transceiver during a downlink calibration operation and an uplink calibration signal being output from each of the plurality of transceivers to the controller during an uplink calibration operation, and
the second wireless communication apparatus executes self-healing processing of reconstructing a downlink beam forming weight for spatial multiplexing by using the transceiver other than the malfunctioning transceiver among the plurality of transceivers.

What is claimed is:

1. A wireless communication apparatus comprising:
a plurality of transceivers;
a calibration transceiver; and
a first controller,
wherein the first controller
detects a malfunction of each of the plurality of transceivers, based on a downlink calibration signal being output from each of the plurality of transceivers to the calibration transceiver during a downlink calibration operation and an uplink calibration signal being output from each of the plurality of transceivers to the first controller during an uplink calibration operation, and
executes self-healing processing of reconstructing a downlink beam forming weight for spatial multiplexing by using the transceiver other than the malfunctioning transceiver among the plurality of transceivers.

2. The wireless communication apparatus according to claim 1, wherein the first controller detects a malfunction of each of the plurality of transceivers, based on a phase or an amplitude of the downlink calibration signal that are output from each of the plurality of transceivers and a phase or an amplitude of the uplink calibration signal.

3. The wireless communication apparatus according to claim 1, wherein the first controller
substitutes zero for a matric element of the malfunctioning transceiver among matrix elements of a propagation path matrix representing a propagation path to a terminal, and
reconstructs the downlink beam forming weight for spatial multiplexing by executing zero-forcing processing by using the propagation path matrix in which zero is substituted for a matrix element of the malfunctioning transceiver.

4. The wireless communication apparatus according to claim 3, wherein the first controller executes singular value decomposition for the propagation path matrix in which zero is substituted for a matrix element of the malfunctioning transceiver, during the zero-forcing processing, and derives, as the downlink beam forming weight for spatial multiplexing to be reconstructed, a generalized inverse matrix of a matrix consisting of right singular vectors acquired by singular value decomposition.

5. The wireless communication apparatus according to claim 1, further comprising a second controller configured to determine whether to execute the self-healing processing, based on the number of malfunctioning transceivers.

6. The wireless communication apparatus according to claim 5, wherein the second controller
calculates a power loss indicating a difference between transmission power of a transmission signal at a time of executing spatial multiplexing in a state where all the plurality of transceivers normally function and transmission power of a transmission signal at a time of executing spatial multiplexing with a downlink beam forming weight for spatial multiplexing being reconstructed by the self-healing processing, for each number of malfunctioning transceivers,
sets a threshold value of the number of malfunctioning transceivers in advance, based on the power loss for each number of malfunctioning transceivers, and
determines whether to execute the self-healing processing, based on a comparison result between the number of malfunctioning transceivers and the threshold value.

7. The wireless communication apparatus according to claim 6, wherein the second controller sets an upper limit value of the number of malfunctioning transceivers, which can maintain the power loss within a predetermined value, in advance as the threshold value.

8. The wireless communication apparatus according to claim 1, further comprising a third controller configure to determine whether to execute the self-healing processing, based on the number of malfunctioning transceivers and a malfunction position of the transceiver.

9. A wireless communication method performed by a wireless communication apparatus including a plurality of transceivers, a calibration transceiver, and a controller, the wireless communication method comprising:
a malfunction detection step of detecting a malfunction of each of the plurality of transceivers, based on a downlink calibration signal being output from each of the plurality of transceivers to the calibration transceiver during a downlink calibration operation and an uplink calibration signal being output from each of the plurality of transceivers to the controller during an uplink calibration operation; and
a reconstruction step of executing self-healing processing of reconstructing a downlink beam forming weight for spatial multiplexing by using the transceiver other than the malfunctioning transceiver among the plurality of transceivers.

10. A wireless communication system comprising:
a first wireless communication apparatus; and
a second wireless communication apparatus, wherein
the first wireless communication apparatus includes
a plurality of transceivers,
a calibration transceiver, and
a controller,
the controller detects a malfunction of each of the plurality of transceivers, based on a downlink calibration signal being output from each of the plurality of transceivers to the calibration transceiver during a downlink calibration operation and an uplink calibration signal being output from each of the plurality of transceivers to the controller during an uplink calibration operation, and
the second wireless communication apparatus executes self-healing processing of reconstructing a downlink beam forming weight for spatial multiplexing by using the transceiver other than the malfunctioning transceiver among the plurality of transceivers.
